(19) United States
(12) Patent Application Publication
(10) Pub. No.: US 2007/0291204 A1
(43) Pub. Date: Dec. 20, 2007

(54) LIQUID CRYSTAL DEVICE AND ELECTRONIC APPARATUS

(75) Inventor: Toshihiro OTAKE, Okaya (JP)

Correspondence Address: HARNESS, DICKEY & PIERCE, P.L.C., P.O. BOX 828, BLOOMFIELD HILLS, MI, 48303, US

(73) Assignee: EPSON IMAGING DEVICES CORPORATION, Azumino-shi (JP)

(21) Appl. No.: 11/696,443

(22) Filed: Apr. 4, 2007

(30) Foreign Application Priority Data
Jun. 15, 2006 (JP) 2006-166010

(51) Int. Cl. G02F 1/1335

(52) U.S. Cl. 349/114

(57) ABSTRACT

A liquid crystal device including a first substrate and a second substrate which oppose each other; a liquid crystal layer interposed between the first substrate and the second substrate; light-reflecting films selectively provided to the second substrate and reflecting incident light from the first substrate side; and light-emitting layers emitting light toward the second substrate and being disposed at the opposite side of the liquid crystal layer with respect to the first substrate in such positions corresponding to regions where the light-reflecting films of the second substrate are not disposed.

### BACKGROUND

1. Technical Field

The present invention relates to liquid crystal devices which form images by modulating light passing through liquid crystal layers. The invention further relates to electronic apparatuses constituted by using the liquid crystal devices.

2. Related Art

At present, in various electronic apparatuses such as mobile phones and mobile data terminals, liquid crystal devices are broadly used, for example, as displays for visually displaying various information relating to the electronic apparatuses. In a liquid crystal device, generally, a liquid crystal layer is disposed between a pair of substrates opposing each other and images such as letters, figures, and diagrams are displayed on the outer surface of a substrate at the downstream of the traveling direction of light by modulating light passing through the liquid crystal layer by each sub-pixel.

As the light passing through the liquid crystal layer, two types of light, i.e., reflected light and transmitted light are thought. In reflected light, extraneous light such as solar light and interior light is reflected in the inside of a liquid crystal device and is supplied to a liquid crystal layer. In transmitted light, light emitted by a lighting means disposed on the outside of a liquid crystal panel, which is a component of a liquid crystal device, is supplied to a liquid crystal layer. A display using reflected light is called a reflective display, and a display using transmitted light is called a transmissive display.

As a liquid crystal device which allows to display both the above-mentioned reflective display and transmissive display, a semi-transmissive/reflective liquid crystal device of which sub-pixels are each partially provided with a light-reflection coating so that each sub-pixel includes a reflective display region and a transmissive display region is known (for example, Patent Document 1: JP-A-2001-66593 (page 4, FIG. 2)). In this liquid crystal device, a light-emitting layer is disposed at each the display side of the liquid crystal panel and the opposite side of the panel so as to correspond to the position of the transmissive display region. In this liquid crystal display, bright display can be achieved in the transmissive display region by using light emitted from the light-emitting layer.

At present, in some electronic apparatuses such as mobile phones, display can be performed on both front and rear sides of a display portion. The liquid crystal device disclosed in Patent Document 1 has a structure for displaying on only one side of the liquid crystal device. Thus, the structure of the device is not one for displaying on both sides. If both-sides display using this liquid crystal device is required, it may be achieved by disposing a liquid crystal device on each of the front and rear sides of the electronic apparatus and displaying on both sides of the electronic apparatus. However, in such a case, the total thickness of the electronic apparatus may be increased.

### SUMMARY

An advantage of some aspects of the present invention is to decrease the thickness of a liquid crystal device which can perform both reflective display and transmissive display and can display on both front side and rear side of the liquid crystal device.

A liquid crystal device according to a first aspect of the invention includes (1) a first substrate and a second substrate which oppose each other, (2) a liquid crystal layer interposed between the first substrate and the second substrate, (3) light-reflecting films selectively provided to the second substrate and reflecting incident light from the first substrate side, and (4) light-emitting layers emitting light toward the second substrate and disposed at the opposite side of the liquid crystal layer with respect to the first substrate in such positions corresponding to regions where the light-reflecting films of the second substrate are not disposed.

In a liquid crystal device having the above-mentioned structure, the first and second substrates are formed of a light-transmissive material such as light-transmissive glass or a light-transmissive plastic. In addition, the light-emitting layers are formed of an organic EL (electroluminescent) or inorganic EL material. The light-reflecting films provided to the second substrate are formed of, for example, aluminum (Al) and reflects extraneous light such as interior light for utilizing the light in display.

In a liquid crystal device having the above-mentioned structure, reflective display can be performed at the first substrate side by using the light-reflecting films provided to the second substrate. Specifically, extraneous light entered from the first substrate side is reflected toward the first substrate. An image is displayed at the first substrate side using this reflected light. On the other hand, at the second substrate side, transmissive display can be performed by using the light-emitting layers disposed at the opposite side of the liquid crystal layer with respect to the first substrate in such positions corresponding to regions where the light-reflecting films of the second substrate are not disposed. Specifically, light emitted from the light-emitting layer enters from the first substrate side and then passes through the second substrate. An image is displayed at the second substrate side using this transmitted light.

Thus, in a liquid crystal device according to the first aspect of the invention, an image is displayed at the first substrate side using light reflected by the light-reflecting films provided to the second substrate, and an image is displayed at the second substrate side using light emitted from the light-emitting layers provided at the opposite side of the liquid crystal layer with respect to the first substrate. Therefore, a liquid crystal device allowing both-sides display is provided by using a single liquid crystal panel composed of two substrates, the first and second substrates. As a result, the total thickness of the liquid crystal device can be decreased compared to that of a known liquid crystal device performing display on both front and rear sides using two liquid crystal panels. Further, since the light-emitting layers are disposed at the opposite side of the liquid crystal layer with respect to the first substrate, a bright display can be performed on the surface of the second substrate using light from the light-emitting layers.

Further, the liquid crystal device according to the first aspect of the invention is provided with a plurality of sub-pixels arrayed in a first direction and a second direction which intersect each other. The plurality of sub-pixels include first sub-pixels each containing the light-reflecting film provided to the second substrate and second sub-pixels each containing the light-emitting layer disposed at the opposite side of the liquid crystal layer with respect to the first substrate. The first sub-pixels may have a length different from that of the second sub-pixels in the above-mentioned second direction and have the same length as that of the second sub-pixels in the first direction. Reversely, the first sub-pixels may have a length different from that of the second sub-pixels in the first direction and have the same length as that of the second sub-pixels in the second direction.

Each of the first sub-pixel and the second sub-pixel is a minimum unit region for performing display. A plurality of first sub-pixels and a plurality of second sub-pixels are planarly arrayed both in the first and second directions to constitute the entire display as a display region for displaying an image. Here, the first direction may be determined as the direction along scanning lines transmitting scanning signals to each of the sub-pixels, and the second direction may be determined as the direction along data lines disposed so as to be orthogonal to the scanning lines and transmitting data signals to each of the sub-pixels.

In many liquid crystal devices performing both-sides display, main display is performed on one display side and subsidiary display is performed on the other display side. In such a case, it may be desirable that the degree of definition of the main display is higher than that of the subsidiary display. In the liquid crystal device according to an embodiment of the present, the first sub-pixels and the second sub-pixels can be designed to be different from each other in size. Therefore, the definition of the display at the front side can be different from that at the rear side. For example, regarding the first sub-pixels and the second sub-pixels, the definition of the main display can be increased by forming the sub-pixels for main display to be larger than those for subsidiary display.

Furthermore, in an embodiment of the invention, the first sub-pixels may be arrayed adjacent to each other along the first direction and similarly the second sub-pixels may be arrayed adjacent to each other along the first direction, and the first sub-pixels and the second sub-pixels may be alternately arrayed along the second direction. Reversely, the first sub-pixels may be arrayed adjacent to each other along the second direction and similarly the second sub-pixels may be arrayed adjacent to each other along the second direction, and the first sub-pixels and the second sub-pixels may be alternately arrayed along the first direction. If the first sub-pixels are arrayed adjacent to each other in both first and second directions and similarly the second sub-pixels are arrayed adjacent to each other in both first and second directions, the display region at the first substrate side and the display region at the second substrate side may be each formed narrowly by being one-sided in a planar region of each of the first substrate and the second substrate.

On the other hand, as in the embodiment of the invention, the first sub-pixels and the second sub-pixels can be efficiently arrayed in the planar regions of the first substrate and the second substrate by disposing the first sub-pixels adjacent to each other along either one of a first or second direction and similarly disposing the second sub-pixels adjacent to each other along the same direction as that of the first sub-pixels and alternately disposing the first sub-pixels and the second sub-pixels along the other direction of the first direction and the second direction. As a result, the display regions at the first substrate side and the second substrate side are broadly formed in planar regions, without being one-sided.

Further, in a liquid crystal device according to the first aspect of the invention, the device is provided with a plurality of sub-pixels arrayed in a first direction and a second direction which intersect each other; the plurality of sub-pixels are composed of first sub-pixels each containing the light-reflecting film provided to the second substrate and second sub-pixels each containing the light-emitting layer disposed at the opposite side of the liquid crystal layer with respect to the first substrate; and at least one of the first substrate and the second substrate is preferably provided with monocolored or multicolored films in a predetermined arrangement so as to correspond to the individual first sub-pixels and second sub-pixels.

In this structure of the liquid crystal device, when monocolored films are provided to the substrates so as to correspond to the individual first sub-pixels and second sub-pixels, display using only that one color, namely, a monocolor display is performed. On the other hand, when multicolored films are provided to the substrates so as to correspond to the individual first sub-pixels and second sub-pixels, a color display using these multicolor can be performed. For example, when three-color films, namely, R (red), G (green), and B (blue) films are provided to the substrates, display using the three R, G, and B colors, namely, full color display can be performed. In addition, examples of the predetermined arrangement include a stripe arrangement, a mosaic arrangement, and a delta arrangement.

Further, in a liquid crystal device according to the first aspect of the invention, the device is provided with a plurality of sub-pixels arrayed in a first direction and a second direction which intersect each other; the plurality of sub-pixels are composed of first sub-pixels each containing the light-reflecting film provided to the second substrate and second sub-pixels each containing the light-emitting layer disposed at the opposite side of the liquid crystal layer with respect to the first substrate; a resin film for controlling the thickness of the liquid crystal layer is provided to the first substrate or the second substrate at the liquid crystal layer side in each of the first sub-pixels; and desirably there is a relationship between the layer thickness t1 of the liquid crystal layer in the first sub-pixels and the layer thickness t2 of the liquid crystal layer in the second sub-pixels as follows:

t1<t2.

This structure is called a multi-gap structure. In a liquid crystal device having this structure, the resin film for controlling the liquid crystal layer thickness is, for example, provided between the light-reflecting film and the second substrate and electrically insulating between the light-reflecting film and a conductive member disposed on the second substrate. That is, the resin film may be an interlayer insulating film. The thickness of the liquid crystal layer can be readily controlled by controlling the thickness of the resin film.

In accordance with an embodiment of the invention, the relationship between the liquid crystal layer thickness t1 in the first sub-pixels and the liquid crystal layer thickness t2 in the second sub-pixels can be controlled to t1<t2. Therefore, crisp display can be performed by equalizing the retardation in the liquid crystal layer in both when light passes through the liquid crystal layer twice in reflective display by the first sub-pixels and when light passes through the liquid crystal layer only once in transmissive display by the second sub-pixels.

A liquid crystal device according to a second aspect of the invention includes (1) a first substrate and a second substrate which oppose each other, (2) a liquid crystal layer interposed between the first substrate and the second substrate, (3) a plurality of sub-pixels composed of first sub-pixels displaying an image at the first substrate side and second sub-pixels displaying an image at the second substrate side, wherein the first sub-pixels and the second sub-pixels are arrayed in a first direction and in a second direction orthogonal to the first direction in a planar view in planar regions of the first substrate and the second substrate, (4) a light-reflecting film disposed on the second substrate in each first sub-pixel and reflecting light toward the direction of the first substrate, and (5) a light-emitting layer disposed at the opposite side of the second substrate with respect to the first substrate in each second sub-pixel and emitting color light toward the second substrate. In this liquid crystal device, the light-reflecting film is not provided in the second sub-pixels and the light-emitting layer is not provided in the first sub-pixels. In addition, since the light-emitting layers are disposed in such positions corresponding to the respective second sub-pixels and emit color light, the display using the second sub-pixels can perform color display.

Further, in a liquid crystal device according to the second aspect of the invention, monocolored or multicolored films are provided in the first sub-pixels in a predetermined arrangement. The color light emitted from one of the light-emitting layers is desirably the same color as that of the color film provided in the first sub-pixel adjacent to the second sub-pixel provided with the one light-emitting layer. Thus, the color structures of sub-pixels can be the same in the side for performing display using the first sub-pixels and the side for performing display using the second sub-pixels

Further, a liquid crystal device according to a third aspect of the invention includes (1) a first substrate and a second substrate which oppose each other, (2) a liquid crystal layer interposed between the first substrate and the second substrate, (3) a third substrate disposed at the opposite side of the second substrate with respect to the first substrate, (4) a fourth substrate disposed at the opposite side of the first substrate with respect to the third substrate, (5) a plurality of sub-pixels composed of first sub-pixels displaying an image at the first substrate side and second sub-pixels displaying an image at the second substrate side, wherein the first sub-pixels and the second sub-pixels are arrayed in a first direction and in a second direction orthogonal to the first direction in a planar view in planar regions of the first substrate and the second substrate, (6) a color film, a light-transmissive resin film disposed on the color film, and a light-transmissive electrode disposed on the light-transmissive resin film, in each first sub-pixel at the first substrate side, (7) a switching element, a resin film disposed on the switching element, and a light-reflecting film disposed on the resin film, in each first sub-pixel at the second substrate side, (8) light-transmissive electrodes disposed on the third substrate and light-emitting layers disposed on the light-transmissive electrodes, and (9) reflecting electrodes disposed on the fourth substrate so as to oppose the light-emitting layers.

In a liquid crystal device according to the third aspect of the invention, desirably, a switching element and a light-transmissive electrode disposed on the switching element and electrically connected to the switching element are provided in each second sub-pixel at the first substrate side, and a color film, a light-transmissive resin film disposed on the color film, and a light-transmissive electrode disposed on the light-transmissive resin film are provided in each second sub-pixel at the second substrate side.

The liquid crystal device according to the third aspect of the invention is called an active matrix type liquid crystal device. The switching elements disposed on the first substrate and the second substrate may be, for example, a three-terminal active element such as a TFT (Thin Film Transistor) element or a two-terminal active element such as a TFD (Thin Film Diode) element. Further, a liquid crystal layer is interposed between the first substrate provided with the switching elements and the second substrate provided with the switching elements to form a liquid crystal panel. In addition, the light-emitting layers disposed on the third substrate may be made of, for example, an organic EL or inorganic EL material. The third substrate provided with the light-emitting layers and the fourth substrate form a lighting unit.

In the liquid crystal device having the above-mentioned structure, a reflective display can be performed by reflecting extraneous light entered from the first substrate side toward the first substrate with the light-reflecting film provided on the second substrate in each of the first sub-pixels. Since a multiple number of first sub-pixels are provided, an image can be displayed at the first substrate side using the reflected light. On the other hand, transmissive display can be performed by that light emitted from light-emitting layers provided at positions corresponding to the respective second sub-pixels enters the second substrate from the first substrate side and passes through the second substrate. Since a multiple number of second sub-pixels are provided, an image can be displayed at the second substrate side using the light from the emitting layers.

In the liquid crystal device according to the third aspect of the invention, the display on the surface of the first substrate and the display on the surface of the second substrate can be separately driven by the switching elements. Therefore, a liquid crystal device displaying at both front and rear sides thereof using a single liquid crystal panel can be certainly constituted.

Further, a liquid crystal device according to a fourth aspect of the invention includes (1) a first substrate and a second substrate which oppose each other, (2) a liquid crystal layer interposed between the first substrate and the second substrate, (3) a plurality of sub-pixels composed of first sub-pixels displaying an image at the first substrate side and second sub-pixels displaying an image at the second substrate side, wherein the first sub-pixels and the second sub-pixels are arrayed in a first direction and in a second direction orthogonal to the first direction in a planar view in planar regions of the first substrate and the second substrate, and (4) the first sub-pixels and the second sub-pixels are alternately disposed in either or both the first and second directions.

In this liquid crystal device, an image is displayed at the first substrate side using a plurality of first sub-pixels, and an image is displayed at the second substrate side using a plurality of second sub-pixels. Therefore, a liquid crystal device allowing both-sides display can be formed by using a single liquid crystal panel composed of two, a first and a second, substrates. As a result, the total thickness of the liquid crystal device can be decreased compared to a known liquid crystal device performing display on both front and rear sides using two liquid crystal panels. In addition, since the light-emitting layers are disposed at positions corresponding to the individual second sub-pixels, bright display can be performed on the surface of the second substrate using light from the light-emitting layers.

Further, in the liquid crystal device according to the invention, desirably, the first sub-pixels and the second sub-pixels are separately driven. With this, the display at the first side and the display at the second side can be independently performed, and thereby various display can be provided.

Further, in the liquid crystal device according to the invention, desirable, a switching element is provided to each first sub-pixel and each second sub-pixel, and that a group of the switching elements provided to the first sub-pixels and a group of the switching elements provided to the second sub-pixels are separately driven. The liquid crystal device with this structure is an active matrix type liquid crystal device. This structure also allows independent displaying at the first side and at the second side by separately driving the group of the switching elements provided to the first sub-pixels and the group of the switching elements provided to the second sub-pixels.

Further, an electronic apparatus according to an aspect of the invention is provided with a liquid crystal device having the above-described structure. The liquid crystal device according to an aspect of the invention can display an image on the surface of a first substrate using a plurality of first sub-pixels and display an image on the surface of a second substrate using a plurality of second sub-pixels. Therefore, both-sides display can be performed by using a single liquid crystal panel composed of two, the first and the second, substrates. As a result, the total thickness of the liquid crystal device can be decreased compared to a known liquid crystal device performing display on both front and rear sides using two liquid crystal panels. Therefore, the total thickness of an electronic apparatus according to an aspect of the invention using this liquid crystal device can be also reduced.

In addition, in the liquid crystal device according to an aspect of the invention, bright display on the surface of a second substrate can be performed using light from light-emitting layers when the light-emitting layers are disposed at positions corresponding to the respective second sub-pixels.

### BRIEF DESCRIPTION OF THE DRAWINGS

The invention will be described with reference to the accompanying drawings, wherein like numbers reference like elements.

FIG. 1 is a cross-sectional view of a liquid crystal device according to an embodiment of the invention.

FIG. 2 is a plan view when seen in the direction indicated by the arrow A in FIG. 1.

FIG. 3 is an enlarged cross-sectional view of a portion indicated by the arrow III in FIG. 1.

FIG. 4 is an enlarged plan view of a portion indicated by the arrow IV in FIG. 2 when seen in the direction indicated by an arrow A in FIG. 3.

FIG. 5 is an enlarged plan view of a portion indicated by the arrow V in FIG. 2 when seen in the direction indicated by an arrow B in FIG. 3.

FIG. 6 is a cross-sectional view taken along the line VI-VI in FIG. 4.

FIG. 7 is a cross-sectional view taken along the line VII-VII in FIG. 5.

FIG. 8 is a cross-sectional view of a liquid crystal device according to another embodiment of the invention.

FIG. 9 is a plan view when seen in the direction indicated by the arrow B in FIG. 8.

FIG. 10 is an enlarged cross-sectional view of a portion indicated by the arrow X in FIG. 8.

FIG. 11 is an enlarged plan view of a portion indicated by the arrow XI in FIG. 9 when seen in the direction indicated by the arrow A in FIG. 10.

FIG. 12 is an enlarged plan view of a portion indicated by the arrow XII in FIG. 9 when seen in the direction indicated by the arrow B in FIG. 10.

FIG. 13 is a cross-sectional view of a main portion of a liquid crystal device according to further another embodiment of the invention.

FIG. 14 is a block diagram illustrating an electronic apparatus according to an embodiment of the invention.

FIG. 15A is a view of an appearance in a closed state of the electronic apparatus shown in FIG. 14.

FIG. 15B is a view of an appearance in an opened state of the electronic apparatus shown in FIG. 14.

### DESCRIPTION OF EXEMPLARY EMBODIMENTS

### Liquid Crystal Device According to a First Embodiment

A liquid crystal device according to an embodiment of the present invention will now be described with referring to an example in which the present invention is applied to a liquid crystal device performing color display driven by a TFT (Thin Film Transistor). In this embodiment, the invention is applied to a liquid crystal device using a channel-etch amorphous-silicon TFT element of a single-gate structure as the TFT element, but is not limited to this embodiment. Further, in the drawings referred in the description below, the sizes of some components may be shown by using different ratios from the actual ratios for easily understanding of characteristic portions.

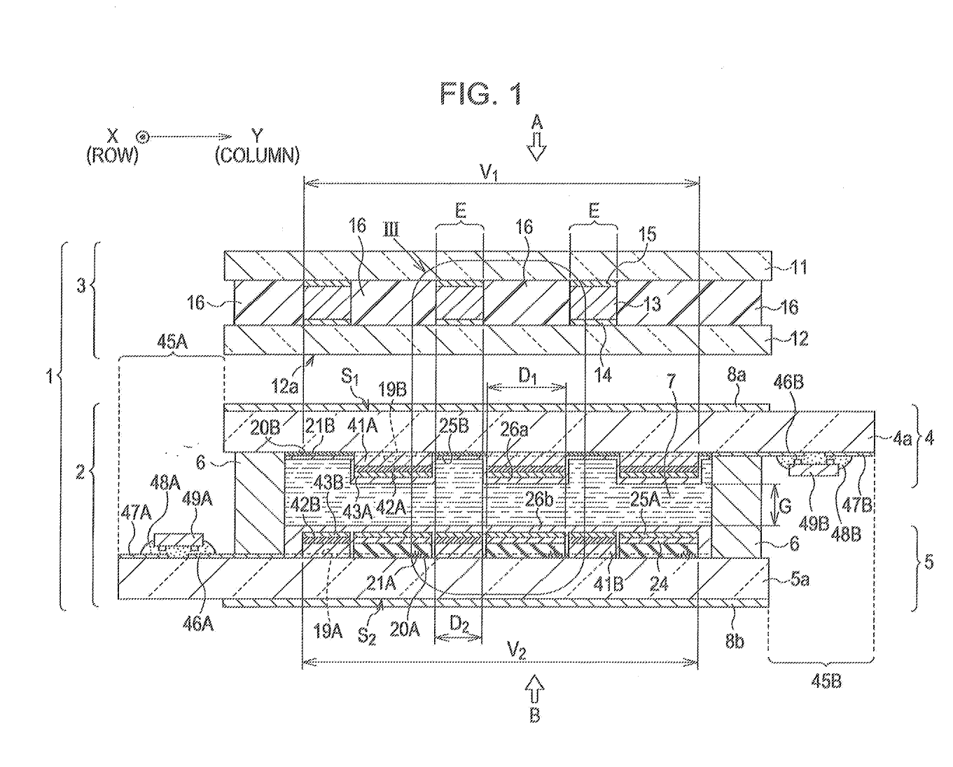

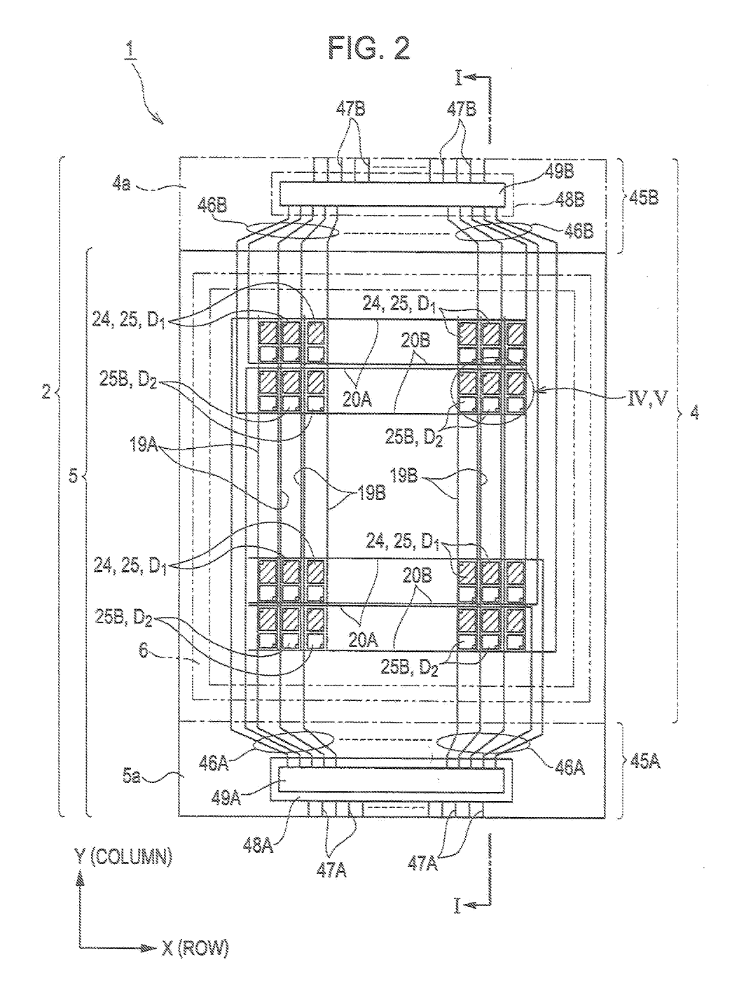

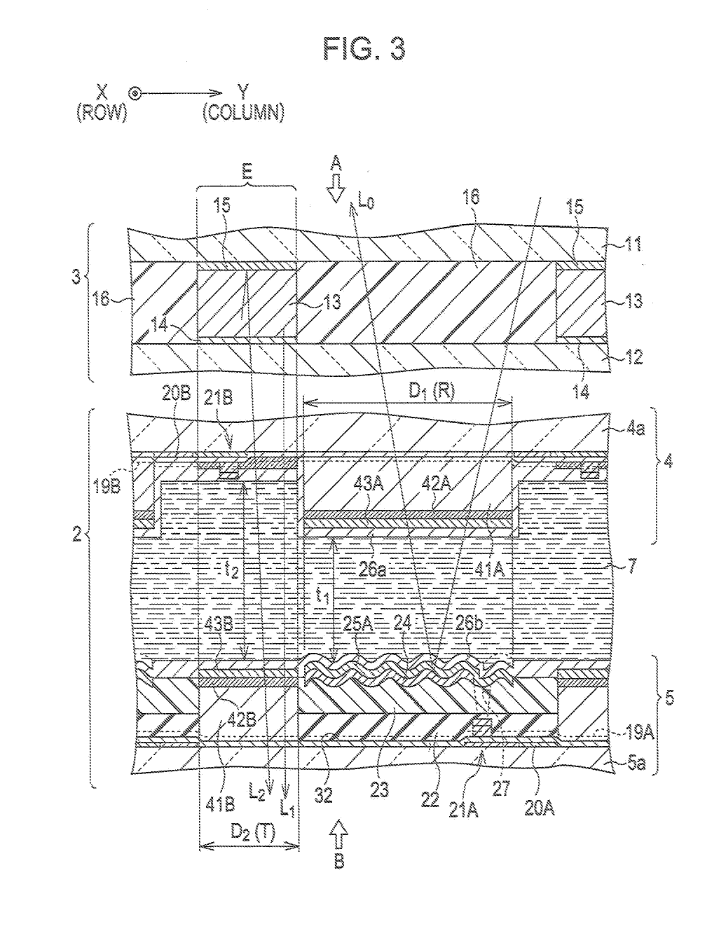

FIG. 1 shows a cross-sectional structure of a liquid crystal device according to an embodiment of the invention. FIG. 2 shows a plan structure of a liquid crystal panel in the liquid crystal device when seen in the direction of the arrow A in FIG. 1. FIG. 1 is a cross-sectional view taken along the line I-I in FIG. 2. FIG. 3 is an enlarged view of a portion indicated by the arrow III in FIG. 1.

In FIG. 1, the liquid crystal device 1 includes a liquid crystal panel 2 and a lighting unit 3. In this liquid crystal device 1, the side indicated by the arrow A is a main view side for performing main display, and the side indicated by the arrow B is a subsidiary view side for performing subsidiary display. In other words, the liquid crystal device 1 according to this embodiment is one composed of the liquid crystal panel 2 for both-sides display at the arrow A side and the arrow B side.

The liquid crystal panel 2 includes a pair of substrates 4 and 5 attached to each other with a sealing member 6 which is a square or rectangular ring when viewed in the direction of the arrow A. The substrate 4 is disposed at the main view side indicated by the arrow A, and a first display surface S₁ is formed on the outer surface of the substrate 4. On the other hand, the substrate 5 is disposed at the subsidiary view side indicated by the arrow B, and a second display surface S2 is formed on the outer surface of the substrate 5.

The substrate 4 includes a first light-transmissive substrate 4a as a first substrate having a rectangular or square shape when viewed in the direction of the arrow A. The first light-transmissive substrate 4a is made of, for example, light-transmissive glass or a light-transmissive plastic. The first light-transmissive substrate 4a is attached with a polarizer 8a on the outer surface thereof. The first light-transmissive substrate 4a may be provided with an optical element such as a phase difference plate in addition to the polarizer 8a, according to need. On the other hand, the substrate 5 opposing the substrate 4 includes a second light-transmissive substrate 5a as a second substrate having a rectangular or square shape when viewed in the direction of the arrow B. The second light-transmissive substrate 5a is made of, for example, light-transmissive glass or a light-transmissive plastic. The second light-transmissive substrate 5a is attached with a polarizer 8b on the outer surface thereof. The second light-transmissive substrate 5a may be provided with an optical element such as a phase difference plate in addition to the polarizer 8b, according to need.

The sealing member 6 forms a gap, a so-called cell gap G, between the substrate 4 and the substrate 5. The sealing member 6 is partially provided with a liquid crystal inlet (not shown). Through this liquid crystal inlet, a liquid crystal is injected between the substrate 4 and the substrate 5 as an electro-optic medium. The injected liquid crystal forms a liquid crystal layer 7 as a layer of an electro-optic medium in the cell gap G. The liquid crystal inlet is sealed with a resin after the completion of the injection of the liquid crystal. The method for injecting a liquid crystal is not limited to injection through a liquid crystal inlet as in above. A liquid crystal may be dropped in a region surrounded by sequential circular sealing members 6 not having the liquid crystal inlet. In addition, in this embodiment, a nematic liquid crystal having a positive dielectric anisotropy may be used as the liquid crystal.

The height of the cell gap G, i.e., the layer thickness of the liquid crystal layer 7, is held constant by a plurality of spacers (not shown) disposed in the cell gap G. The spacers can be formed by randomly (i.e., arbitrarily) placing a plurality of spherical resin members on the surface of the substrate 4 or 5. Further, columnar spacers may be formed by photolithography at predetermined positions.

The lighting unit 3 includes a substrate 11 as a fourth substrate and a substrate 12 as a third substrate. The substrate 11 and the substrate 12 are a pair of light-transmissive substrates. The lighting unit 3 is disposed at the main view side of the liquid crystal panel 2, namely, the substrate 12 is disposed so as to face the side of the substrate 4, where the arrow A is drawn.

Further, a plurality of reflecting electrodes 15 are provided on the inner surface of the substrate 11 in a predetermined arrangement when viewed in the direction of the arrow A. On the other hand, light-transmissive electrodes 14 are provided on the inner surface of the substrate 12, and an organic light-emitting layer 13 is provided as a light-emitting layer on each of the light-transmissive electrodes 14. The light-transmissive electrode 14 and the organic light-emitting layer 13 are disposed to planarly overlap the corresponding reflecting electrode 15 on the substrate 11. Thus, the reflecting electrode 15, the light-transmissive electrode 14, and the organic light-emitting layer 13 planarly overlap with each other to form a light-emitting unit E. In addition, light-transmissive resin layers 16 are formed at regions other than the light-emitting units E between the substrate 11 and the substrate 12.

The reflecting electrodes 15 are made of a metal having light-emitting ability, such as aluminum (Al) or an Al alloy. The light-transmissive electrodes 14 are made of, for example, indium tin oxide (ITO). The organic light-emitting layers 13 are made of, for example, a polyparaphenylenevinylene containing a fluorescent dye or its precursor as a derivative thereof. In this embodiment, the organic light-emitting layers 13 emit white light. The light-transmissive resin layers 16 are made of, for example, a light-transmissive or photosensitive resin. Though it is not shown, an electron-transporting layer made of an aluminium-quinolinol complex or the like is provided between each of the organic light-emitting layers 13 and the reflecting electrodes 15.

With referring to FIG. 2, the liquid crystal panel 2 is provided with a plurality of regions D₁ and a plurality of regions D₂. The regions indicated by reference numeral D₁ (namely, regions indicated by oblique lines in FIG. 2) correspond to first sub-pixels which are each a unit region for display at the first display surface S₁ in FIG. 1. The regions indicated by reference numeral D₂ in FIG. 2 correspond to second sub-pixels which are each a unit region for displaying at the second display surface S₂ in FIG. 1. The first sub-pixels D₁ and the second sub-pixels D₂ are each a region where a pixel electrode and a strip electrode described below planarly overlap and are each a minimum unit region for displaying. FIG. 2 is a plan view of the liquid crystal device when seen in the direction of the arrow A in FIG. 1. In FIG. 2, the substrate 5 is disposed at the backward side with respect to the drawing sheet, and the substrate 4 is disposed at the forward side with respect to the drawing sheet. Therefore, electrodes and wiring provided to the inside of the liquid crystal panel 2 are not basically seen from the outside by the presence of the substrate 4, but the electrodes and wiring are shown in full lines in FIG. 2 for convenience in description.

The first sub-pixels D₁ and the second sub-pixels D₂ are planarly arrayed. The first sub-pixels D₁ are arrayed adjacent to each other in the row direction X (namely, in the horizontal direction of FIG. 2) as a first direction. In addition, the second sub-pixels D₂ are also arrayed adjacent to each other. On the other hand, in the column direction Y (namely, in the vertical direction of FIG. 2) as a second direction, the first sub-pixels D₁ and the second sub-pixels D₂ are alternately arrayed. In other words, a plurality of lines of the first sub-pixels D₁ arrayed along the row direction X and a plurality of lines of the second sub-pixels D₂ arrayed along the row direction X are alternately arrayed in the column direction Y.

An inner structure of the liquid crystal panel 2 composed of the substrate 4 and the substrate 5 will now be described in detail. In the liquid crystal device 1 in FIG. 1, the inside structure of the liquid crystal panel 2 in the first sub-pixel D₁ is different from that in the second sub-pixel D₂.

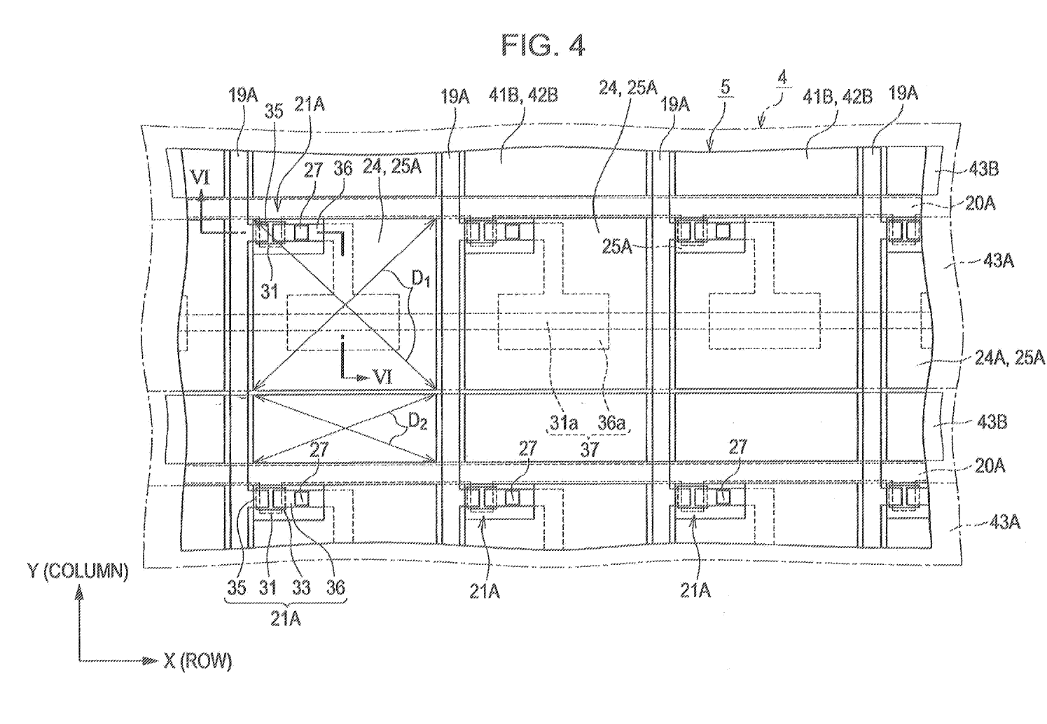

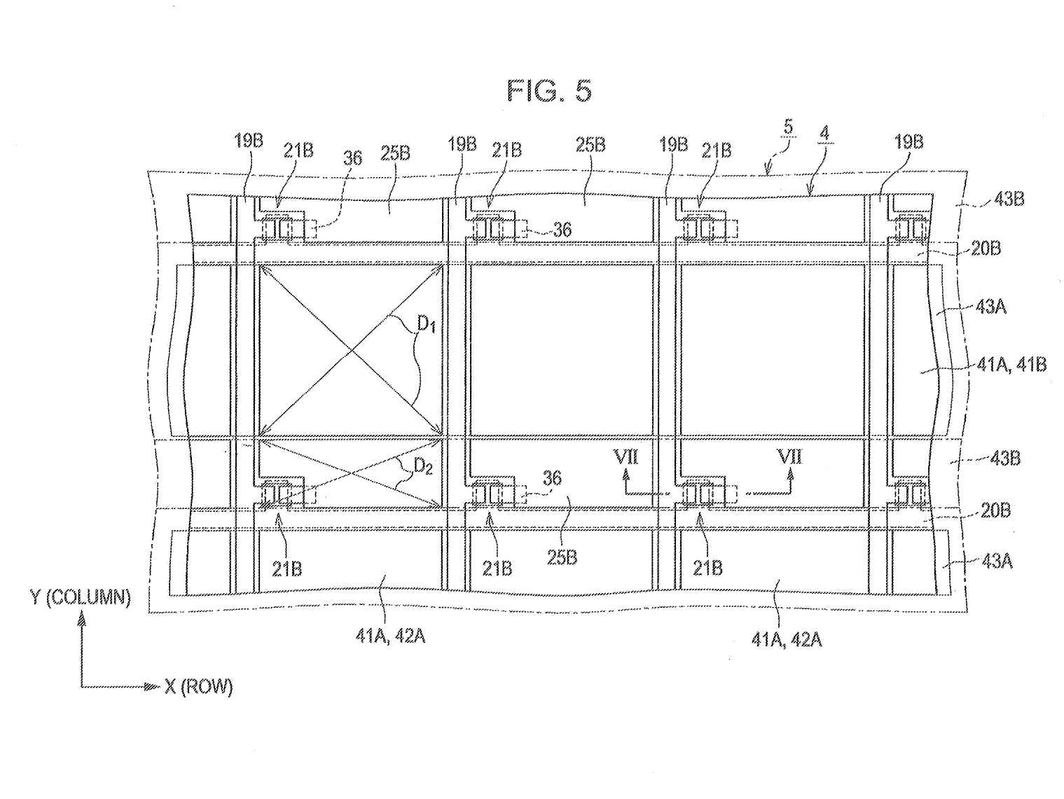

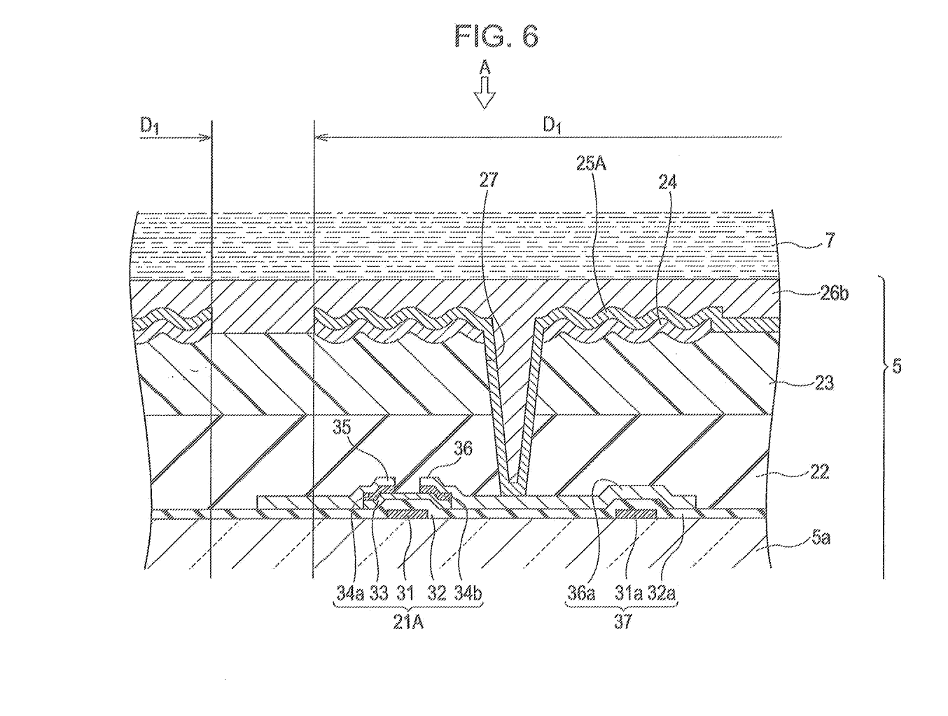

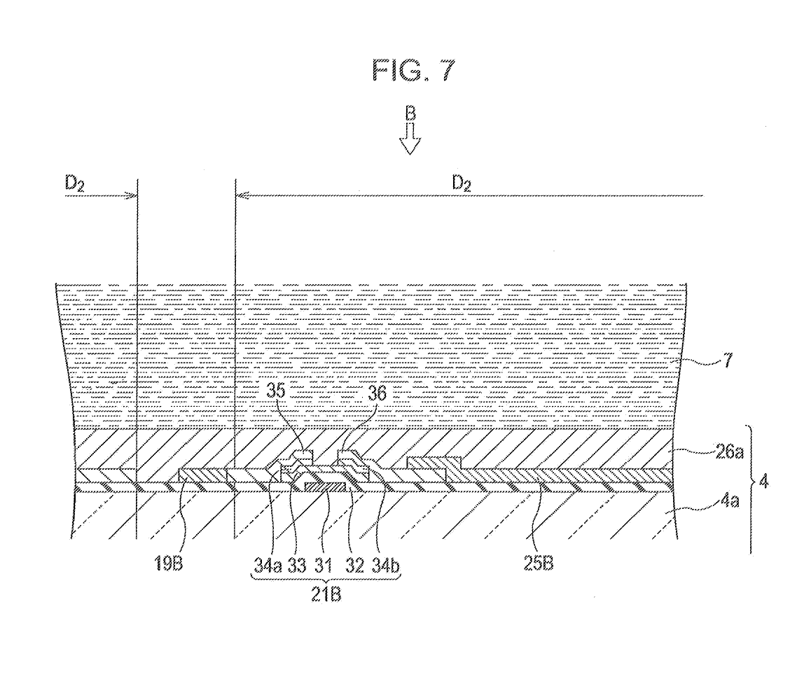

First, the inside structure of the liquid crystal panel 2 in the first sub-pixel D₁ will be described. FIGS. 4 and 5 are enlarged plan views of a portion indicated by the arrow IV, V in FIG. 2. Further, FIG. 6 is a cross-sectional view taken along the line VI-VI in FIG. 4. FIG. 7 is a cross-sectional view taken along the line VII-VII in FIG. 5. FIGS. 6 and 7 mainly show a TFT element. Further, FIG. 4 mainly shows a planar structure of the substrate 5 when seen in the direction of the arrow A in FIG. 3. FIG. 5 mainly shows a planar structure of the substrate 4 when seen in the direction of the arrow B in FIG. 3.

In FIG. 3, a source line 19A extends on the inner surface of the second light-transmissive substrate 5a in the column direction Y (namely, the horizontal direction of FIG. 3). In addition, a gate line 20A extends in the row direction X (namely, the vertical direction with respect to the drawing sheet of FIG. 3). Further, a TFT element 21A which is an active element functioning as a switching element is formed so as to be connected to the source line 19A and the gate line 20A. The source line 19A functions as a data line for transmitting data signals to the TFT element 21A. The gate line 20A functions as a scanning line for transmitting scanning signals to the TFT element 21A.

Further, a protective film 22 is disposed on the TFT element 21A, the source line 19A, and the gate line 20A so as to cover them. On the protective film 22, a rough resin film 23 is disposed as an insulating film. Further, a light-reflecting film 24 is disposed on the rough resin film 23, and a light-transmissive pixel electrode 25A is disposed on the light-reflecting film 24. In addition, an alignment film 26b is disposed on the pixel electrode 25A. This alignment film 26b is subjected to alignment treatment such as rubbing treatment to determine the initial alignment of liquid crystal molecules near the substrate 5.

Usually, the protective film 22 is made of a nitride (SiN) film or a silicon dioxide (SiO₂) film which has light-transmissivity and insulation. The rough resin film 23 is formed by, for example, patterning a resin having light-transmissivity, photosensitivity, and insulation, such as an acryl resin or polyimide resin, by photolithography.

The light-reflecting film 24 is formed by, for example, patterning a light-reflecting material such as aluminum (Al) or an Al alloy by photo etching. The pixel electrode 25A is formed by, for example, patterning a metal oxide such as indium tin oxide (ITO) by photo etching. The alignment film 26b is formed by, for example, applying polyimide by printing.

A plurality of light-reflecting films 24 and a plurality of pixel electrodes 25A are arrayed in a matrix form in the row direction X and the column direction Y on the substrate 5 in FIG. 2. The light-reflecting film 24 and the pixel electrode 25A are, as shown in FIG. 4 which is an enlarged plan view of a portion indicated by the arrow IV in FIG. 2, disposed near the corresponding intersection of the source line 19A and the gate line 20A. The light-reflecting film 24 and the pixel electrode 25A are connected to the corresponding TFT element 21A.

In FIG. 3, the protective film 22 and the rough resin film 23 are provided with a contact hole 27 which is a through-hole functioning as an opening for electrically connecting the pixel electrode 25A and the TFT element 21A. The contact hole 27 is disposed at a position such that the contact hole 27 does not overlap the element body of the TFT element 21A but overlaps the pixel electrode 25A when planarly viewed in the direction of the arrow A in FIG. 3.

The TFT element 21A used in this embodiment is an amorphous silicon TFT. As shown in FIG. 6, the TFT element 21A includes a gate electrode 31, a gate-insulating film 32, a semiconductor film 33 formed of amorphous silicon (a-Si), N⁺—Si films 34a and 34b, a source electrode 35, and a drain electrode 36. The TFT element 21A in this embodiment is constituted as a channel-etch TFT element having a single, bottom-gate structure.

In addition, a storage capacitor 37 is disposed apart from the TFT element 21A with a little distance. This storage capacitor 37 is provided for preventing an excessive reduction in the capacity of the pixel electrode 25A. The storage capacitor 37 is composed of a first electrode 31a formed with the same material as that of the gate electrode 31 in the same layer, an insulating film 32a formed of the same material as that of the gate-insulating film 32 in the same layer and covering the first electrode 31a, and a second electrode 36a formed in the same layer as the drain electrode 36 and covering the insulating film 32a. As shown in FIG. 4, the first electrode 31a extends along the gate lines 20A and intersects the source lines 19A. The second electrode 36a has a large rectangular shape.

In FIG. 6, one end of the drain electrode 36 is connected to the semiconductor film 33 via the N⁺—Si film 34b, and the other end of the drain electrode 36 extends to the storage capacitor 37 to become the second electrode 36a. Further, the drain electrode 36 is electrically connected to the pixel electrode 25A via the contact hole 27. In addition, as shown in FIG. 4, the source electrode 35 is formed from the branched source line 19A. The gate electrode 31 is formed from the branched gate line 20A extending in the direction orthogonal to the source line 19A.

In FIG. 6, the pixel electrode 25A and the TFT element 21A are disposed in separate layers by providing an interlayer insulating film composed of the protective film 22 and the rough resin film 23 under the pixel electrode 25A. With this, the surface of the substrate 5 can be efficiently used compared to a structure having the pixel electrode 25A and the TFT element 21A in the same layer. For example, the area of the pixel electrode 25A, namely, the pixel area, can be increased without being prevented by the TFT element 21A by disposing the pixel electrode 25A and the TFT element 21A in different layers. Therefore, the liquid crystal device can perform clean display.

Further, in FIG. 3, a color film 41A constituting a color filter is disposed on the inner surface of the first light-transmissive substrate 4a opposing the substrate 5 in the first sub-pixel D₁ . An overcoat film 42A is disposed on the color film 41A, and a light-transmissive strip electrode 43A is disposed on the overcoat film 42A. Further, an alignment film 26a is disposed on the light-transmissive strip electrode 43A. The overcoat film 42A functions as a protective film for protecting the color filter. The alignment film 26a is formed by, for example, applying polyimide by printing.

The color film 41A is disposed in each of the first sub-pixels D₁ and has a shape of a rectangular or square dot (namely, island-like shape) when viewed in the direction of the arrow A. Further, a plurality of color films 41A are arrayed in a matrix form in the row direction X and the column direction Y when viewed in the direction of the arrow A.

Each color film 41A has an optical characteristic to transmit one of R (red), G (green), and B (blue) light rays. The color films 41A for R, G, and B light rays are arrayed in a predetermined arrangement such as a stripe arrangement, a mosaic arrangement, or a delta arrangement, when viewed in the direction of the arrow A. The optical characteristics of the color films 41A are not limited to three primary colors of R, G, and B. The color films 41A may have characteristics to transmit one of three primary colors of C (cyan), M (magenta), and Y (yellow).

The strip electrodes 43A are formed by, for example, patterning ITO into predetermined stripes by photo etching. As shown in FIG. 4, the light-transmissive strip electrodes 43A each extend in the row direction X (the horizontal direction in FIG. 4) and are arrayed in the column direction Y (the vertical direction in FIG. 4) in parallel to each other with a predetermined distance.

The dot-shaped pixel electrodes 25A arrayed on the substrate 5 in the row direction X and the strip electrodes 43A extending on the substrate 4 in the row direction X planarly overlap each other. By thus overlapping both electrodes, the first sub-pixels D₁ , which are a minimum unit for display, are constituted. In FIG. 1, by arraying a plurality of first sub-pixels D₁ in a matrix form in the row direction X and the column direction Y in the XY plane, a first display region V₁ is formed at the outer side of the substrate 4 (the side where the arrow A is drawn), and an image such as a letter, a figure, or a diagram is displayed in the first display region V₁.

When color display is performed using the color films 41A of three, R, G, and B, color rays in the first display region V₁, three first sub-pixels D₁ corresponding to the three, R, G, and B, color films 41A form one pixel. On the other hand, when a monocolor display is performed using black and white or optional two colors, one first sub-pixel D₁ forms one pixel.

In this embodiment, as shown in FIG. 3, the light-reflecting film 24 is disposed in the first sub-pixel D₁. Thus, the first sub-pixel D₁ provided with the light-reflecting film 24 is a reflective display region R. Extraneous light Lo entered from the main view side indicated by the arrow A is reflected by the light-reflecting film 24 in the first sub-pixels D₁ as the reflective display region R.

The rough resin film 23 in each of the first sub-pixels D₁ is provided with the rough pattern by randomly forming a plurality of recesses and a plurality of projections in the plane when viewed in the direction of the arrow A. The light-reflecting film 24 is disposed on the thus formed rough resin film 23 with a uniform film thickness and thereby has the same rough pattern as that of the rough resin film 23. Since the light-reflecting film 24 itself has the rough pattern, the light Lo to be reflected by the light-reflecting film 24 can be formed into properly scattered light or light having an appropriate direction, not specular reflection.

Next, an inner structure of the liquid crystal panel 2 in the second sub-pixel D₂ will be described. In FIG. 3, a source line 19B extends on the inner surface of the first light-transmissive substrate 4a in the column direction Y (namely, the horizontal direction in FIG. 3). In addition, a gate line 20B extends in the row direction X (namely, the vertical direction with respect to the drawing sheet in FIG. 3). Further, a TFT element 21B which is an active element functioning as a switching element is formed so as to be connected to the source line 19B and the gate line 20B in the second sub-pixel D₂. As shown in FIG. 7, the TFT element 21B includes a gate electrode 31, a gate-insulating film 32, a semiconductor film 33 formed of amorphous silicon (a-Si), N⁺—Si films 34a and 34b, a source electrode 35, and a drain electrode 36. Since this TFT element 21B has the same structure as that of the TFT element 21A in FIG. 6, the detailed description of this is omitted. The source line 19B in FIG. 3 functions as a data line for transmitting data signals to the TFT element 21B. The gate line 20B functions as a scanning line for transmitting scanning signals to the TFT element 21B.

In FIG. 7, the TFT element 21B is electrically connected to a pixel electrode 25B. As shown in FIG. 2, a plurality of pixel electrodes 25B are arrayed in a matrix form in the row direction X and the column direction Y on the substrate 4. Each of the pixel electrodes 25B is, as shown in FIG. 5 which is an enlarged plan view of a portion indicated by the arrow V in FIG. 2, disposed near the corresponding intersection of the source line 19B and the gate line 20B and is connected to the corresponding TFT element 21B.

Specifically, in FIG. 7, the pixel electrode 25B is disposed at a position so as to partially planarly overlap one end of the drain electrode 36 of the TFT element 21B. This pixel electrode 25B is formed by, for example, patterning ITO by photo etching. Further, an alignment film 26a is disposed on the pixel electrode 25B. This alignment film 26a is subjected to alignment treatment such as rubbing treatment to determine the initial alignment of liquid crystal molecules near the substrate 4 in the second sub-pixel D₂.

Further, in FIG. 3, a color film 41B constituting a color filter is disposed on the inner surface of the second light-transmissive substrate 5a opposing the substrate 4 in the second sub-pixel D₂. An overcoat film 42B is disposed on the color film 41B, and a light-transmissive strip electrode 43B is disposed on the overcoat film 42B. Further, an alignment film 26b is disposed on the strip electrode 43B. The overcoat film 42B functions as a protective film for protecting the color filter.

The color film 41B is disposed in each of the second sub-pixel D₂ and has a shape of a rectangular or square dot (namely, island-like shape) when viewed in the direction of the arrow B. Further, a plurality of color films 41B are arrayed in a matrix form in the row direction X and the column direction Y when viewed in the direction of the arrow B.

Each color film 41B has an optical characteristic to transmit one of R (red), G (green), and B (blue) light rays. The color films 41B for R, G, and B light rays are arrayed in a predetermined arrangement such as a stripe arrangement, a mosaic arrangement, or a delta arrangement when viewed in the direction of the arrow A. The optical characteristics of the color films 41B are not limited to three primary colors of R, G, and B. The color films 41B may have characteristics to transmit one of three primary colors of C (cyan), M (magenta), and Y (yellow).

The strip electrodes 43B are formed by, for example, patterning ITO into predetermined stripes by photo etching. As shown in FIG. 5, the strip electrodes 43B each extend in the row direction X (the horizontal direction in FIG. 5) and are arrayed in the column direction Y (the vertical direction in FIG. 5) in parallel to each other with a predetermined distance.

The dot-shaped pixel electrodes 25B arrayed on the substrate 4 in the row direction X and the strip electrode 43B extending on the substrate 5 in the row direction X planarly overlap each other. By thus overlapping both electrodes, the second sub-pixels D₂, which are a minimum unit for display, are constituted. In FIG. 1, by arraying a plurality of second sub-pixels D₂ in a matrix form in the row direction X and the column direction Y in the XY plane, a second display region V₂ is formed at the outer side of the substrate 5 (the side where the arrow B is drawn), and an image such as a letter, a figure, or a diagram is displayed in the second display region V₂.

In the second display region V₂, similarly, three second sub-pixel D₂ corresponding to the three R, G, and B color films 41B form one pixel when color display is performed using color films 41B of three R, G, and B color rays. On the other hand, when monocolor display is performed using black and white or optional two colors, one second sub-pixel D₂ forms one pixel.

In FIG. 3, the light-reflecting film 24 disposed in each of the first sub-pixels D₁ is not provided to the second sub-pixel D₂. Thus, the second sub-pixel D₂ where the light-reflecting film is not provided is a transmissive display region T. Light rays L₁ and L₂ emitted from a lighting unit 3 are supplied to the liquid crystal panel 2 from the arrow A side and pass through the second sub-pixel D₂ as the transmissive display region T.

In this embodiment, an interlayer insulating film as a resin film for adjusting the thickness of the liquid crystal layer is provided on the TFT element 21A in each of the first sub-pixels D₁ as the reflective display region R. The resin film is composed of the protective film 22 and the rough resin film 23. On the other hand, an interlayer insulating film is not provided on the TFT element 21B in each of the second sub-pixels D₂ as the transmissive display region T. Therefore, there is a relationship between the layer thickness t1 of the liquid crystal layer 7 in the first sub-pixels D₁ and the layer thickness t2 of the liquid crystal layer 7 in the second sub-pixels D₂ as follows:

t1<t2.

Preferably, t1=t2/2. The adjustment of the layer thickness of the liquid crystal layer 7 is performed for achieving crisp display by equalizing the retardation (And) of the liquid crystal layer 7 in a case of a reflective display in which light L₀ passes through the liquid crystal layer 7 twice in the first sub-pixels D₁ as the reflective display region R and in a case of a transmissive display in which light L₁ passes through the liquid crystal layer 7 only once in the second sub-pixels D₂ as the transmissive display region T. Here, “An” means a refractive anisotropy, and “d” means a liquid crystal layer thickness.

In FIG. 1, the second light-transmissive substrate 5a constituting the substrate 5 includes a protrusion 45A protruding to the outside of the substrate 4. On the surface of the protrusion 45A, wiring lines 46A are formed by photo etching. A plurality of wiring lines 46A are disposed when viewed in the direction of the arrow A and are arrayed with a distance therebetween along the vertical direction with respect to the drawing sheet. In addition, a plurality of external connecting terminals 47A are disposed at the end of the protrusion 45A and are arrayed with a distance therebetween along the vertical direction with respect to the drawing sheet. The end of the protrusion 45A provided with the external connecting terminals 47A is connected to, for example, an FPC substrate (not shown).

In FIG. 2, the plurality of wiring lines 46A extend in the column direction Y in the region surrounded by the sealing member 6. A part of these wiring lines 46A are directly connected to the source lines 19A on the substrate 5 and function as data lines. Another part of the plurality of wiring lines 46A are patterned to extend in the column direction Y along the side end of the substrate 5 in the region surrounded by the sealing member 6 and then to be bended so as to extend in the row direction X. The wiring lines 46A formed in this pattern are directly connected to the gate lines 20A on the substrate 5 and function as scanning lines.

On the surface of the protrusion 45A, a driving IC 49A is mounted by a COG (chip-on-glass) method using an ACF (anisotropic conductive film) 48A. The driving IC 49A transmits data signals to the source lines 19A and transmits scanning signals to the gate lines 20A. A plurality of TFT elements 21A are a group of switching elements which are connected to the source lines 19A and the gate lines 20A and are driven by the driving IC 49A. In other words, a plurality of first sub-pixels D₁ each provided with the TFT element 21A are driven by the driving IC 49A. The driving IC 49A may be formed with one IC chip or may be formed with a plurality of IC chips, according to need. When the driving IC 49A is constituted by a plurality of IC chips, the IC chips are mounted on the protrusion 45A by being arrayed in the horizontal direction in FIG. 2.

Furthermore, in FIG. 1, the first light-transmissive substrate 4a constituting the substrate 4 includes a protrusion 45B protruding to the outside of the substrate 5. On the surface of this protrusion 45B, wiring lines 46B are formed by photo etching. A plurality of wiring lines 46B are arrayed when viewed in the direction of the arrow A and are arrayed with a distance therebetween along the vertical direction with respect to the drawing sheet. In addition, a plurality of external connecting terminals 47B are disposed at the end of the protrusion 45B and are arrayed with a distance therebetween along the vertical direction with respect to the drawing sheet. The end of the protrusion 45B provided with the external connecting terminals 47B is connected to, for example, an FPC substrate (not shown).

In FIG. 2, the plurality of wiring lines 46B extend in the column direction Y in the region surrounded by the sealing member 6. A part of these wiring lines 46B are directly connected to the source lines 19B on the substrate 4 and function as data lines. Another part of the plurality of wiring lines 46B are patterned to extend in the column direction Y along the side end of the substrate 4 in the region surrounded by the sealing member 6 and then to be bended so as to extend in the row direction X. The wiring lines 46B formed in this pattern are directly connected to the gate lines 20B on the substrate 4 and function as scanning lines.

On the surface of the protrusion 45B, a driving IC 49B is mounted by a COG method using an ACF 48B. The driving IC 49B transmits data signals to the source lines 19B and transmits scanning signals to the gate lines 20B. A plurality of TFT elements 21B are a group of switching elements which are connected to the source lines 19B and the gate lines 20B and are driven by the driving IC 49B. In other words, a plurality of second sub-pixels D₂ each provided with the TFT element 21B are driven by the driving IC 49B. The driving IC 49B may be formed with one IC chip or may be formed with a plurality of IC chips, according to need.

In FIG. 3, the light-emitting units E each including the light-emitting layer 13 of the lighting unit 3 are disposed at positions corresponding to the second sub-pixels D₂. These light-emitting units E are not provided at positions corresponding to the first sub-pixels D₁ . Therefore, light emitted from the light-emitting layers 13 emanates from regions corresponding to the light-emitting units E in the light emanating surface 12a (see FIG. 1) of the substrate 12 toward the second sub-pixels D₂ of the liquid crystal panel 2.

In the thus structured liquid crystal device 1 in FIG. 1, reflective display is performed by the first sub-pixels D₁ by using extraneous light such as solar light and interior light at the main view side indicated by the arrow A. On the other hand, transmissive display is performed by the second sub-pixels D₂ by using the lighting unit 3 at the subsidiary view side indicated by the arrow B.

When the reflective display is performed at the main view side, in FIG. 3, extraneous light L₀ entered into the liquid crystal panel 2 from the direction of the arrow A through the substrate 4 passes through the liquid crystal layer 7 and enters the substrate 5. The light is reflected by the light-reflecting film 24 in the first sub-pixel D₁ and then is supplied to the liquid crystal layer 7 again. During light is supplied to the liquid crystal layer 7 in this manner, a predetermined voltage specified by scanning signals and data signals is applied between the pixel electrode 25A of the substrate 5 and the strip electrode 43A of the substrate 4 and the alignment of the liquid crystal molecules in the liquid crystal layer 7 is controlled for each first sub-pixel D₁. As a result, the light supplied to the liquid crystal layer 7 is modulated for each first sub-pixel D₁. When this modulated light passes through the polarizer 8a (see FIG. 1) of the substrate 4, the transmission of the light is controlled by the polarization property of the polarizer 8a for each first sub-pixel D₁ to display an image such as a letter, a figure, or a diagram on the surface of the substrate 4. This is visibly recognized from the direction of the arrow A.

On the other hand, when transmissive display is performed at the subsidiary view side, in FIG. 3, white light L₁ from light-emitting layer 13 passes through the light-transmissive electrode 14 and the substrate 12 and emanates from the light emanating surface 12a (see FIG. 1) by lighting on the light-emitting layer 13 of the lighting unit 3. In addition, white light L₂ which emanates toward the substrate 11 from the light-emitting layer 13 is reflected by the reflecting electrode 15 on the substrate 11 and then passes the light-emitting layers 13. The light passes through the light-transmissive electrode 14 and the substrate 12 and then emanates from the light emanating surface 12a. These emanating light L₁ and L₂ permeate through the substrate 4 from the direction of the arrow A and enter the liquid crystal panel 2 and then are supplied to the liquid crystal layer 7.

During light is supplied to the liquid crystal layer 7 in this manner, a predetermined voltage specified by scanning signals and data signals is applied between the pixel electrode 25B of the substrate 4 and the strip electrode 43B of the substrate 5, and the alignment of the liquid crystal molecules in the liquid crystal layer 7 is controlled for each second sub-pixel D₂. As a result, the light supplied to the liquid crystal layer 7 is modulated for each second sub-pixel D₂. When this modulated light passes through the polarizer 8b (see FIG. 1) of the substrate 5, the transmission of the light is controlled by the polarization property of the polarizer 8b for each second sub-pixel D₂ to display an image such as a letter, a figure, or a diagram on the surface of the substrate 5. This is visibly recognized in the direction of the arrow B. Here, the light L₁ and L₂ emitted from the light-emitting layer 13 is white light, but light having a specific wavelength in the light L₁ and L₂ can be selected by transmitting the light L₁ and L₂ to color film 41B, and therefore a color display can be performed.

Furthermore, the first sub-pixels D₁ for the reflective display and the second sub-pixels D₂ for the transmissive display are separately driven. Specifically, in FIG. 2, the plurality of first sub-pixels D₁ are driven by driving the TFT elements 21A provided to the respective first sub-pixels D₁ by using the driving IC 49A. Similarly, the plurality of second sub-pixels D₂ are driven by driving the TFT elements 21B provided to the respective second sub-pixels D₂ by using the driving IC 49B.

As described above, in the liquid crystal device according to this embodiment, the display at the main view side indicated by the arrow A and the display at the subsidiary view side indicated by the arrow B can be separately driven by the liquid crystal panel 2 in FIG. 1. In this liquid crystal device 1, an image is displayed on the surface S₁ of the substrate 4 using a plurality of first sub-pixels D₁, and an image is displayed on the surface S2 of the substrate 5 using a plurality of second sub-pixels D₂. Therefore, a liquid crystal device allowing both-sides displaying can be constituted by using a single liquid crystal panel 2 composed of two, i.e., the substrates 4 and 5. Consequently, the total thickness of the liquid crystal device can be decreased compared to that of a known liquid crystal device displaying images on both front and rear sides using two liquid crystal panels.

In addition, since the light-emitting units E are disposed at the positions corresponding to the individual second sub-pixels D₂, bright display on the surface S₂ of the substrate 5 can be performed using light L₁ and L₂ from the light-emitting layers 13 of the light-emitting units E.

Further, in this embodiment, as shown in FIG. 4, the first sub-pixels D₁ and the second sub-pixels D₂ are different in size. Specifically, the area of each first sub-pixel D₁ is larger than that of each second sub-pixel D₂. Generally, in a liquid crystal device for displaying on both sides, a main display is performed on one side and a subsidiary display is performed on the other side. In such a case, it is thought that the definition of a main display is desirable higher than that of a subsidiary display. In the liquid crystal device according to this embodiment, the area of each first sub-pixel D₁ is larger than that of each second sub-pixel D₂. Therefore, the definition of the display on a first display surface S₁, which is the surface of the substrate 4 and is used for main display, can be higher than that of the display on a second display surface S2, which is the surface of the substrate 5 and is used for subsidiary display.

Further, in this embodiment, as shown in FIG. 2, the first sub-pixels D₁ are arrayed adjacent to each other in the row direction X (namely, the horizontal direction in FIG. 2), and similarly the second sub-pixels D₂ are also arrayed adjacent to each other. On the other hand, in the column direction Y (namely, the vertical direction in FIG. 2), the first sub-pixels D₁ and the second sub-pixels D₂ are alternately arrayed. With this arrangement, the first sub-pixels D₁ and the second sub-pixels D₂ are efficiently arrayed in the planar regions of the first display region V₁ and second display region V₂ in FIG. 1. Consequently, the first display region V₁ and the second display region V₂ are broadly formed in the XY plane without being one-sided.

### Liquid Crystal Device According to a Second Embodiment

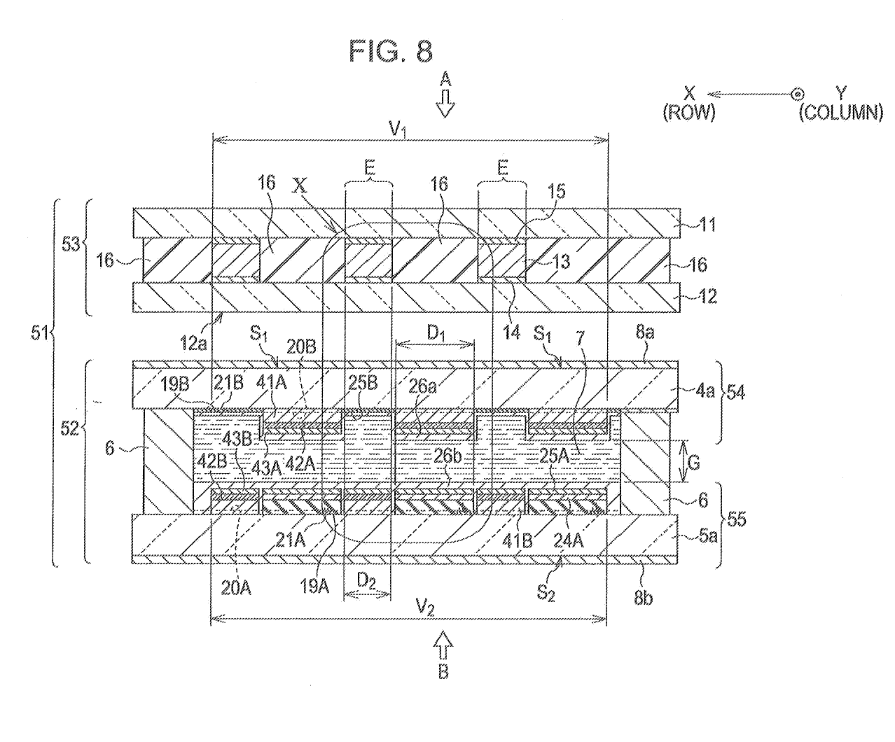

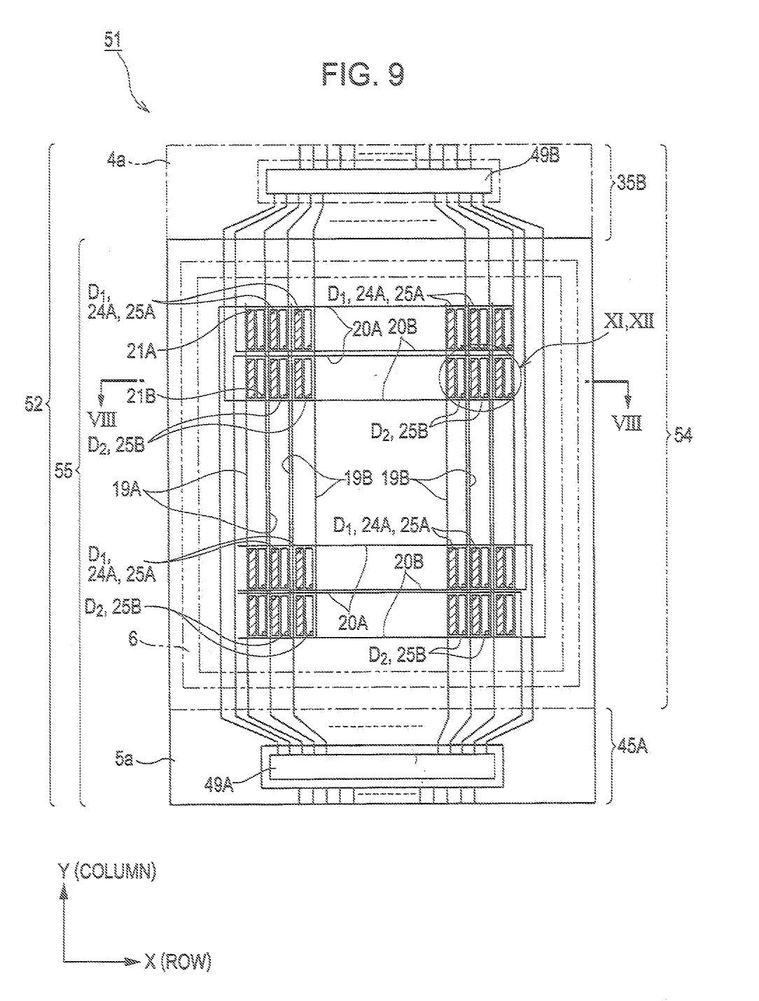

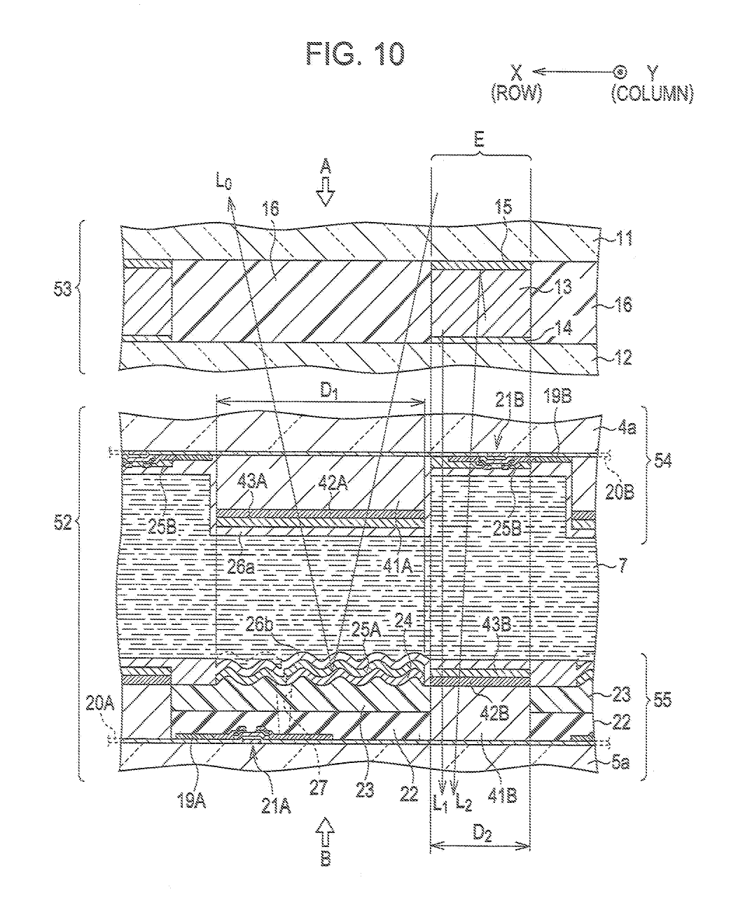

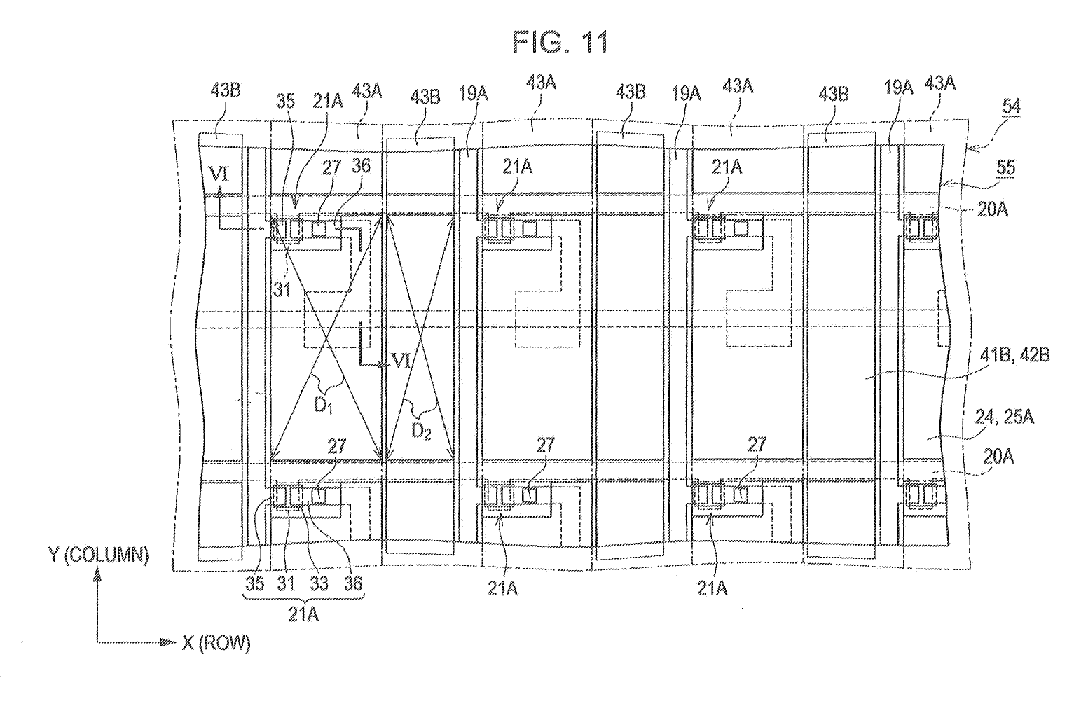

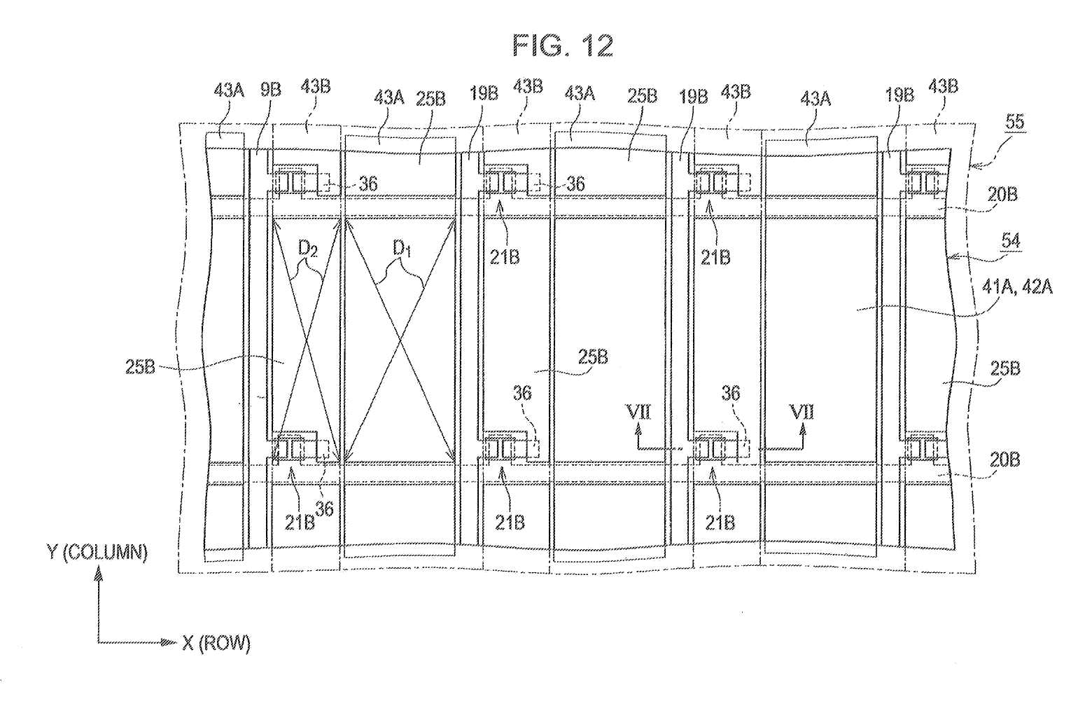

A liquid crystal device according to another embodiment of the invention will now be described. FIG. 8 shows a cross-sectional structure of a liquid crystal device 51 according to a second embodiment of the invention. FIG. 9 shows a plan structure when viewed in the direction of the arrow B in FIG. 8. FIG. 8 is a cross-sectional view taken along the line VIII-VIII in FIG. 9. FIG. 10 is an enlarged view of a portion indicated by the arrow X in FIG. 8. FIGS. 11 and 12 are enlarged views of a portion indicated by the arrow XI, XII in FIG. 9. FIG. 11 mainly shows a plan structure of a substrate 55 when viewed in the direction of the arrow A in FIG. 10. FIG. 12 mainly shows a plan structure of a substrate 54 when viewed in the direction of the arrow B in FIG. 10.

The structure of the liquid crystal device 51 in FIG. 9 according to this embodiment is approximately the same as that of the liquid crystal device 1 shown in FIG. 2 except that the structures and arrangement of first sub-pixels D₁ and second sub-pixels D₂ in the region surrounded by a sealing member 6. Here, the liquid crystal device 51 will be described with a focus on the structures and arrangement of the first sub-pixels D₁ and the second sub-pixels D₂. The liquid crystal device 51 shown in FIG. 9 according to the second embodiment includes the same components as those adopted in the first embodiment shown in FIG. 2, and thus the same components are denoted by the same reference numerals and description thereof will be omitted.

In FIG. 8, the liquid crystal device 51 includes a liquid crystal panel 52 and a lighting unit 53. In the liquid crystal device 51, the main view side where main display is performed is indicated by the arrow A, and the subsidiary view side where subsidiary display is performed is indicated by the arrow B. In other words, the liquid crystal device 51 according to this embodiment includes a liquid crystal panel 52 performing both-sides display by displaying on both the arrow A side and the arrow B side.

The liquid crystal panel 52 includes a pair of substrates 54 and 55 attached to each other with a sealing member 6 which is a rectangular or square ring when viewed in the direction of the arrow A. The substrate 54 is disposed at a main view side indicated by the arrow A, and a first display surface S₁ is disposed on the outer surface of the substrate 54. On the other hand, the substrate 55 is disposed at the subsidiary view side indicated by the arrow B, and a second display surface S2 is disposed on the outer surface of the substrate 55.

The lighting unit 53 includes a substrate 11 as a fourth substrate and a substrate 12 as a third substrate. The substrates 11 and 12 are a pair of light-transmissive substrates. The lighting unit 53 is disposed at the main view side of the liquid crystal panel 52, namely, the lighting unit 53 is disposed in such a manner that the substrate 12 faces the substrate 54 at the side where the arrow A is drawn. This lighting unit 53 has the same structure as that of the lighting unit 3 shown in FIG. 3. That is, a plurality of reflecting electrodes 15 are provided on the inner surface of the substrate 11 in a predetermined arrangement when viewed in the direction of the arrow A. Further, light-transmissive electrodes 14 and organic light-emitting layers 13 are provided on the inner surface of the substrate 12. These light-transmissive electrodes 14 and the organic light-emitting layers 13 are arranged to planarly overlap the respective reflecting electrodes 15 on the substrate 11. Thus, each of the reflecting electrodes 15, the light-transmissive electrodes 14, and the organic light-emitting layers 13 planarly overlap with each other to form a light-emitting unit E. In addition, light-transmissive resin layers 16 are disposed at regions other than the light-emitting units E between the substrate 11 and the substrate 12.

As shown in FIG. 9, the liquid crystal panel 52 is provided with regions of a plurality of first sub-pixels D₁ and a plurality of second sub-pixels D₂. The first sub-pixel regions D₁ and the second sub-pixel regions D₂ are planarly disposed in side-by-side relationship with each other. In FIG. 9, the first sub-pixels D₁ are the regions shown by oblique lines.

The liquid crystal device 51 according to this embodiment are different from the liquid crystal device 1 in FIG. 2 in the structure and arrangement of the first sub-pixels D₁ ad the second sub-pixels D₂. Specifically, the first sub-pixels D₁ are arrayed adjacent to each other in the column direction Y (namely, the vertical direction in FIG. 9) as a second direction. Similarly, the second sub-pixels D₂ are also arrayed adjacent to each other. On the other hand, in the row direction X (namely, in the horizontal direction in FIG. 9) as a first direction, the first sub-pixels D₁ and the second sub-pixels D₂ are alternately arrayed. That is, lines of the plurality of first sub-pixels D₁ arrayed along the column direction Y and lines of the plurality of second sub-pixels D₂ arrayed along the column direction Y are alternately arrayed along the row direction X.

In FIG. 10, the layer structure of the inside of the liquid crystal panel 52 in the first sub-pixel D₁ is the same as that in the first sub-pixels D₁ of the liquid crystal panel 2 in FIG. 3. Specifically, as shown in FIG. 10, source lines 19A extend on the inner surface of the second light-transmissive substrate 5a in the column direction Y (namely, the vertical direction with respect to the drawing sheet of FIG. 10). Gate lines 20A extend in the row direction X (namely, the horizontal direction of FIG. 10). Further, TFT elements 21A are each connected to the corresponding source line 19A and the gate line 20A. The TFT element 21A used in the liquid crystal device 51 according to this embodiment has a cross-sectional structure taken along the line VI-VI in FIG. 11, which is the same structure of that of the TFT element 21A according to the first embodiment shown in FIG. 6, the detailed description of this is omitted.

Further, a protective film 22 is disposed on the TFT element 21A, the source line 19A, and the gate line 20A for covering them. On the protective film 22, a rough resin film 23 is disposed as an insulating film. Further, a light-reflecting film 24 is disposed on the rough resin film 23, and a light-transmissive pixel electrode 25A is disposed on the light-reflecting film 24. In addition, an alignment film 26b is disposed on the pixel electrode 25A.

In FIG. 9, a plurality of light-reflecting films 24 and a plurality of pixel electrodes 25A are arrayed on the substrate 55 in a matrix form in the row direction X and the column direction Y. As shown in FIG. 11, which is an enlarged view of a portion indicated by the arrow XI in FIG. 9, the light-reflecting films 24 and the pixel electrodes 25A are each disposed near the corresponding intersection of the source line 19A and the gate line 20A and are each connected to the corresponding TFT element 21A. Further, in FIG. 10, the protective film 22 and the rough resin film 23 are provided with a contact hole 27 which is a through-hole functioning as an opening for electrically connecting the pixel electrode 25A and the TFT element 21A. The contact hole 27 is disposed at a position such that the contact hole 27 does not overlap the element body of the TFT element 21A but overlaps the pixel electrode 25A when planarly viewed in the direction of the arrow A.

Next, a color film 41A constituting a color filter is disposed on the inner surface of the first light-transmissive substrate 4a opposing the substrate 55 in the first sub-pixel D₁ . An overcoat film 42A is disposed on the color film 41A, and a light-transmissive strip electrode 43A is disposed on the overcoat film 42A. Further, an alignment film 26a is disposed on the strip electrode 43A.

As shown in FIG. 11, in this embodiment, the strip electrodes 43A each extend in the column direction Y (the vertical direction in FIG. 11) and are arrayed in the row direction X (the horizontal direction in FIG. 11) in parallel to each other with a predetermined distance. A plurality of dot-shaped pixel electrodes 25A arrayed on the substrate 55 in the column direction Y and the strip electrode 43A extending on the substrate 54 in the column direction Y planarly overlap each other. By thus overlapped both electrodes, first sub-pixels D₁ , which are a minimum unit for display, are constituted. In FIG. 8, by arraying a plurality of first sub-pixels D₁ in a matrix form in the row direction X and the column direction Y in the XY plane, a first display region V₁ is formed at the outer side of the substrate 54 (the side where the arrow A is drawn), and an image such as a letter, a figure, or a diagram is displayed in the first display region V₁.

Then, in FIG. 10, the layer structure of the inside of the liquid crystal panel 52 in the second sub-pixel D₂ is the same as that in second sub-pixel D₂ of the liquid crystal panel 2 in FIG. 3. Specifically, as shown in FIG. 10, a source line 19B extends on the inner surface of the second light-transmissive substrate 4a in the column direction Y (namely, the vertical direction with respect to the drawing sheet of FIG. 10). In addition, a gate line 20B extends in the row direction X (namely, the horizontal direction of FIG. 10). Further, a TFT element 21B is connected to the source line 19B and the gate line 20B. The TFT element 21B has a cross-sectional structure taken along the line VII-VII in FIG. 12, which is the same as that of the TFT element 21B shown in FIG. 7, the detailed description of this is omitted.

The TFT element 21B is electrically connected to the pixel electrode 25B. In FIG. 9, a plurality of pixel electrodes 25B are arrayed on the substrate 54 in a matrix form along the row direction X and the column direction Y. Each of the pixel electrodes 25B is, as shown in FIG. 12 which is an enlarged view of a portion indicated by the arrow XII in FIG. 9, disposed near the corresponding intersection of the source line 19B and the gate line 20B and is connected to the corresponding TFT element 21B.

Specifically, the pixel electrode 25B is disposed such that a part of the pixel electrode 25B planarly overlaps with one end of the drain electrode 36 of the TFT element 21B. The pixel electrode 25B is made by, for example, patterning ITO by photo etching. Further, an alignment film 26a is disposed on the pixel electrode 25B.

Next, in FIG. 10, a color film 41B is disposed on the inner surface of the second translucent substrate 5a opposing the substrate 54 in the second sub-pixels D₂. An overcoat film 42B is disposed on the color film 41B, and a light-transmissive strip electrode 43B is disposed on the overcoat film 42B. Further, an alignment film 26a is disposed on the strip electrode 43B.

In this embodiment, as shown in FIG. 12, the strip electrodes 43B each extend in the column direction Y (the vertical direction in FIG. 12) and are arrayed in the row direction X (the horizontal direction in FIG. 12) in parallel to each other with a predetermined distance. A plurality of dot-shaped pixel electrodes 25B arrayed on the substrate 54 in the column direction Y and the strip electrode 43B extending on the substrate 55 in the column direction Y planarly overlap each other. By thus overlapped both electrodes, second sub-pixels D₂, which are a minimum unit for display, are constituted. In FIG. 8, by arraying a plurality of second sub-pixels D₂ in a matrix form in the row direction X and the column direction Y in the XY plane, a second display region V₂ is formed at the outer side of the substrate 55 (the side where the arrow B is drawn), and an image such as a letter, a figure, or a diagram is displayed in this second display region V₂.

In FIG. 10, the light-emitting units E each including the light-emitting layer 13 of the lighting unit 53 are disposed at positions corresponding to the second sub-pixels D₂. These light-emitting units E are not provided at positions corresponding to the first sub-pixels DJ. Therefore, light emitted from the light-emitting layers 13 emanates from regions corresponding to the light-emitting units E in the light emanating surface 12a (see FIG. 8) of the substrate 12 toward the second sub-pixels D₂ of the liquid crystal panel 52.

The liquid crystal device 51 in FIG. 9 according to this embodiment can similarly display at both sides, i.e., at the main view side indicated by the arrow A and at the subsidiary view side indicated by the arrow B, by the liquid crystal panel 52 in FIG. 8. In this liquid crystal device 51, an image is displayed on the surface of the substrate 54 using a plurality of first sub-pixels D₁, and an image is displayed on the surface of the substrate 55 using a plurality of second sub-pixels D₂. Therefore, a liquid crystal device allowing both-sides displaying can be formed by using a single liquid crystal panel 52 composed of two, i.e., a substrate 54 and a substrate 55. Consequently, the total thickness of the liquid crystal device can be decreased compared to that of a known liquid crystal device displaying images on both front and rear sides using two liquid crystal panels.

In addition, since the light-emitting units E are disposed at the positions corresponding to the individual second sub-pixels D₂, bright display on the surface S₂ of the substrate 55 can be performed by using light L₁ and L₂ from the light-emitting layers 13 of the light-emitting units E.

Similarly, in this embodiment, as shown in FIG. 11, the first sub-pixel D₁ and the second sub-pixel D₂ are different in size. Specifically, the area of each first sub-pixel D₁ is larger than that of each second sub-pixel D₂. With this, the definition of the display on a first display surface S₁ which is the surface of the substrate 54 and is used for main display can be higher than that of the display on a second display surface S₂ which is the surface of the substrate 55 and is used for subsidiary display.

Further, in this embodiment, as shown in FIG. 9, the first sub-pixels D₁ are arrayed adjacent to each other in the column direction Y (namely, the vertical direction in FIG. 9), and similarly the second sub-pixels D₂ are also arrayed adjacent to each other. In the row direction X (namely, the horizontal direction in FIG. 9), the first sub-pixels D₁ and the second sub-pixels D₂ are alternately arrayed. With this arrangement, the first sub-pixels D₁ and the second sub-pixels D₂ are efficiently arrayed in the planar regions of the first display region V₁ and the second display region V₂ in FIG. 8. Consequently, the first display region V₁ and the second display region V₂ are broadly formed in the XY plane without being one-sided.

### Liquid Crystal Device According to a Third Embodiment

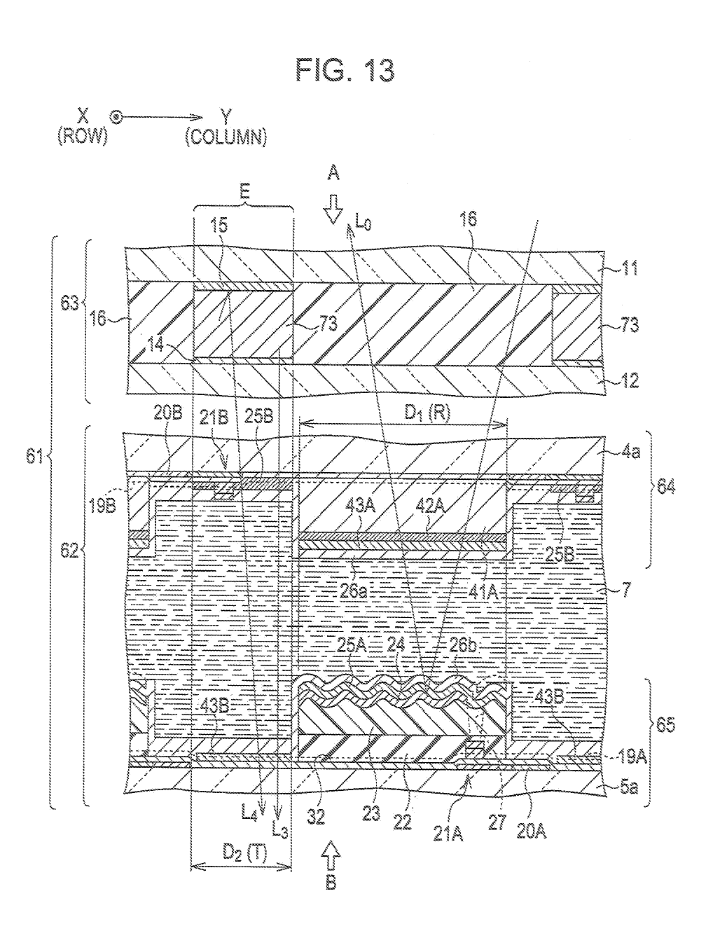

A liquid crystal device according to another embodiment of the invention will now be described. FIG. 13 shows a cross-sectional structure of a portion where a first sub-pixels D₁ and a second sub-pixels D₂ are disposed adjacent to each other in a liquid crystal device 61 according to a third embodiment of the invention. The whole structure of the liquid crystal device 61 of FIG. 13 according to this embodiment is approximately the same as that of the liquid crystal device 1 shown in FIG. 3 except that the structures of a lighting unit 63 and a liquid crystal panel 62 in a second sub-pixel D₂. Therefore, the liquid crystal device 61 will be described with a focus on the structure of the liquid crystal panel 62 in the second sub-pixels D₂. The liquid crystal device 61 shown in FIG. 13 according to the third embodiment includes the same components as those adopted in the first embodiment shown in FIG. 3, and thus the same components are denoted by the same reference numerals and description thereof will be omitted.

In FIG. 13, the liquid crystal device 61 includes a liquid crystal panel 62 and a lighting unit 63. In the liquid crystal device 61, the main view side where main display is performed is indicated by the arrow A, and the subsidiary view side where subsidiary display is performed is indicated by the arrow B. In other words, the liquid crystal device 61 according to this embodiment includes a liquid crystal panel 62 performing both-sides display on both the arrow A side and the arrow B side.

In the liquid crystal device 61 shown in FIG. 13, the structure of the liquid crystal panel 62 in the first sub-pixel D₁ is the same as that of the liquid crystal panel 2 in FIG. 3. In the liquid crystal panel 2 of FIG. 3, gate-insulating films 32 are disposed on the entire substrate 5a in the second sub-pixel D₂, and the color film 41B and the overcoat film 42B are disposed on the gate-insulating film 32. However, in the liquid crystal panel 62 shown in FIG. 13, no color films nor overcoat films are disposed on the substrate 5a in the second sub-pixels D₂. That is, in the second sub-pixel D₂, only a strip electrode 43B is disposed on the gate-insulating film 32 on the substrate 5a.

The structure of the lighting unit 63 is the same as that of the lighting unit 3 in FIG. 3 except for a light-emitting layer 73. In FIG. 3, the light-emitting layer 13 emits white light. On the other hand, in FIG. 13, the light-emitting layer 73 emits colored light.

As described above, in display using the second sub-pixels D₂, namely, in a transmissive display, color display can be performed as in the liquid crystal device 1 shown in FIG. 3 by emitting colored light from the light-emitting layers 73 of the lighting units 63 which supply light into the second sub-pixels D₂, even if color films are not provided to the substrate 65 in the second sub-pixels D₂.

Further, in this embodiment, the color of light emitted by a light-emitting layer 73 in FIG. 13 is the same as that of the color film 41A disposed in the first sub-pixel D₁ adjacent to the second sub-pixel D₂ provided with the light-emitting layer 73. The light L₃ and L₄ emitted from the light-emitting layer 73 is B (blue) when the color film 41A is B (blue). The light L₃ and L₄ emitted from the light-emitting layer 73 is G (green) when the color film 41A is G (green). The light L₃ and L₄ emitted from the light-emitting layer 73 is R (red) when the color film 41A is R (red).

Thus, the color structures of sub-pixels at the main view side A performing display using the first sub-pixels D₁ and at the subsidiary view side B performing display using the second sub-pixels D₂ can be the same, provided that the color of light emitted from the light-emitting layer 73 and the color of the color film 41A are the same in the first sub-pixel D₁ and the second sub-pixel D₂ adjacent to each other

### Other Embodiments

The invention has been described with referring to the embodiments above, but is not limited to them. The invention can be variously modified in the scope of appended claims. For example, in the above-mentioned embodiments, the display in the first display region V₁ is reflective display and the display in the second display region V₂ is transmissive display. However, reversely, the display in the first display region V₁ may be transmissive display and the display in the second display region V₂ may be reflective display.

Further, in the above-mentioned embodiments, the invention is applied to a liquid crystal device using a channel-etch amorphous-silicon TFT element of a single-gate structure. The TFT element is a three-terminal switching element and is used as the switching element of the liquid crystal device. However, the invention can be applied to a liquid crystal device using an amorphous-silicon TFT element of other structure. In addition, the invention can be applied to an active matrix type liquid crystal device using a TFT element other than the amorphous-silicon TFT element, such as a high-temperature polysilicon TFT element or a low-temperature polysilicon TFT element.

The invention can be also applied to a liquid crystal device using a TFD (Thin Film Diode) element, a two-terminal switching element, as the switching element.

In the above-described embodiments, as shown in FIGS. 3 and 10, the invention is applied to a liquid crystal device which can perform full-color display by using three-color films 41A of R, G, and B, or three-color films 41B of R, G, and B. However, the invention can be applied to a liquid crystal device performing monocolor display using a color film of one color. In addition, the invention can be applied to a liquid crystal device performing black and white display by a structure not using colored films.

In the above-mentioned embodiments, the invention is applied to an active matrix liquid crystal device using a switching element. However, the invention can be applied to a passive matrix type liquid crystal device not using switching elements.

### Embodiment of Electronic Apparatus

An electronic apparatus according to an embodiment of the invention will now be described. This embodiment is merely an exemplary embodiment of the invention, and the invention is not limited to this.

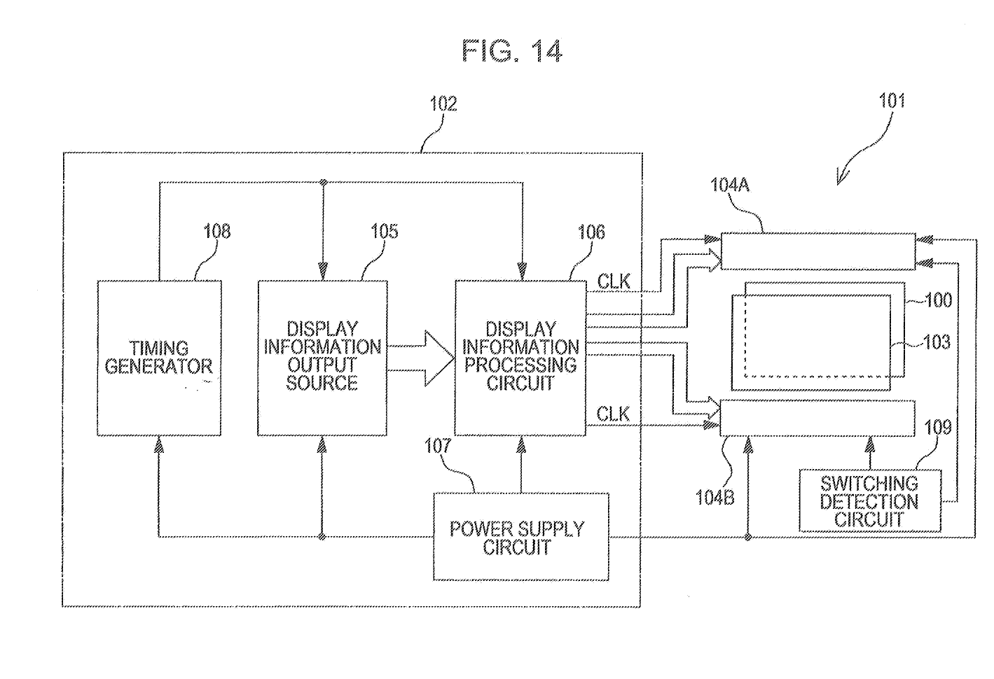

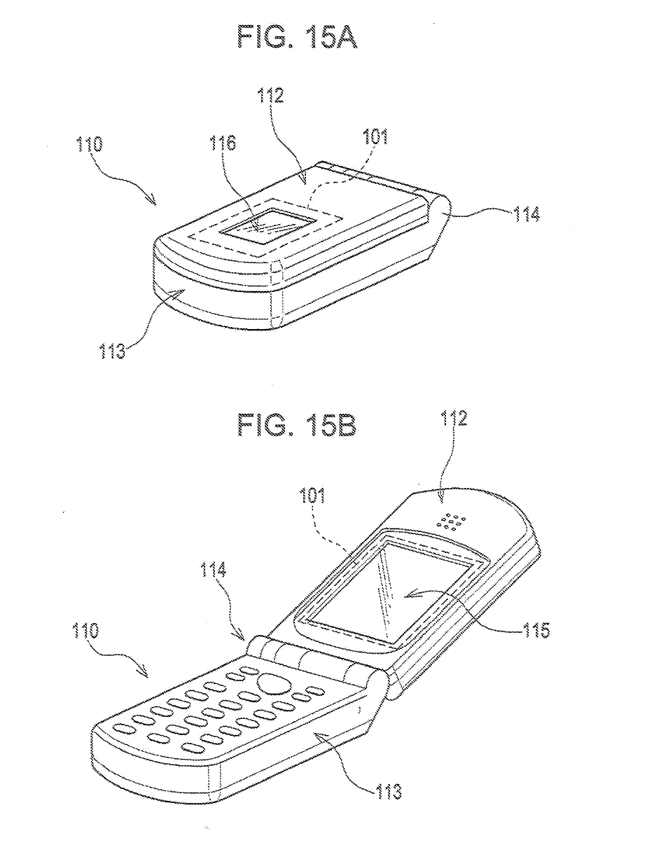

FIG. 14 is a block diagram illustrating an electronic apparatus according to an embodiment of the invention. FIGS. 15A and 15B show a flip phone as an example of the electronic apparatus shown by the block diagram in FIG. 14. The electronic apparatus shown in FIG. 14 includes a liquid crystal device 101 and a controlling circuit 102 controlling the liquid crystal device 101. The controlling circuit 102 includes a display information output source 105, a display information processing circuit 106, a power supply circuit 107, and a timing generator 108. The liquid crystal device 101 includes a liquid crystal panel 103, a lighting unit 100, a first driving circuit 104A, and a second driving circuit 104B.

The display information output source 105 includes a memory such as an ROM (Read Only Memory) or an RAM (Random Access Memory), a storage unit such as various disks, and a tuning circuit for synchronously output digital image signals. Further, the display information output source 105 supplies display information such as image signals in a predetermined format to the display information processing circuit 106 based on various types of clock signals generated by the timing generator 108.

Further, the display information processing circuit 106 includes various types of known circuits such as an amplification/inversion circuit, a rotation circuit, a gamma correction circuit, and a clamp circuit. The display information processing circuit 106 processes input display information and supplies the image information to the first driving circuit 104A or the second driving circuit 104B together with clock signals CLK. The first driving circuit 104A and the second driving circuit 104B are general terms for a test circuit together with a scanning line driving circuit or a data line driving circuit. The power supply circuit 107 supplies a predetermined voltage to the above-mentioned components.

The electronic apparatus shown by the block diagram in FIG. 14 is constituted, for example, as a flip phone 110 shown in FIGS. 15A and 15B. In this mobile phone 110, a display unit 112 provided with a liquid crystal panel 101 is openably connected to a manipulation body 113 via a hinge 114. The liquid crystal panel 101 can perform display on both front and rear sides. The liquid crystal panel 101 operates as a main display 115 performing main display when the display unit 112 is opened. On the other hand, the liquid crystal panel 101 operates as a sub-display 116 for performing subsidiary display when the display unit 112 is folded on the manipulation body 113.

Here, the display is converted to the main display 115 or the sub-display 116 by opening or folding the mobile phone 110. Therefore, as shown in FIG. 14, this electronic apparatus is provided with a switching detection circuit 109 for detecting its folding state. This switching detection circuit 109 outputs a detection result to the liquid crystal device 101.

The liquid crystal device 101 of FIG. 14 can be constituted by using, for example, the liquid crystal device 1 shown in FIG. 2 or the liquid crystal device 51 shown in FIG. 9. In the liquid crystal device 1 or 51, an image is displayed on the substrate 4 or 54 using a plurality of first sub-pixels D₁ and an image is displayed on the surface of the substrate 5 or 55 using a plurality of second sub-pixels D₂. Therefore, both-sides display can be performed by a single liquid crystal panel 2 or 52 composed of a pair of the substrates 4 and 5 or the substrates 54 and 55. Consequently, the total thickness of the liquid crystal device can be decreased compared to a known liquid crystal device performing a display on both front and rear sides using two liquid crystal panels. Therefore, the total thickness of the mobile phone 110, using this liquid crystal device, shown in FIGS. 15A and 15B can be decreased. Further, in this embodiment, the liquid crystal panel 101 of FIGS. 15A and 15B is constituted by the liquid crystal device 1 of FIG. 1 or the liquid crystal device 51 of FIG. 8. Consequently, when the liquid crystal panel 101 in FIGS. 15A and 15B is operated as the sub-display 116, the lighting unit 100 in FIG. 14 is turned on to supply light to the liquid crystal panel 101.

### Modified Embodiments

In addition to the above-described mobile phone, examples of the electronic apparatus include personal computers, liquid crystal televisions, viewfinder-type video tape recorders, monitor-direct-view-type video tape recorders, car navigation apparatuses, pagers, electronic organizers, calculators, word processors, work stations, video phones, and POS terminals.

The entire disclosure of Japanese Patent Application No.2006-166010, filed June 15,2006 is expressly incorporated by reference herein.

What is claimed is:

1. A liquid crystal device comprising:
a first substrate and a second substrate which oppose each other;
a liquid crystal layer interposed between the first substrate and the second substrate;
light-reflecting films selectively provided to the second substrate and reflecting incident light from the first substrate side; and
light-emitting layers emitting light toward the second substrate and being disposed at the opposite side of the liquid crystal layer with respect to the first substrate in such positions corresponding to regions where the light-reflecting films of the second substrate are not disposed.

2. The liquid crystal device according to claim 1, the device further comprising a plurality of sub-pixels arrayed in a first direction and a second direction which intersect each other, wherein
the plurality of sub-pixels include first sub-pixels each containing the light-reflecting film provided to the second substrate and second sub-pixels each containing the light-emitting layer disposed at the opposite side of the liquid crystal layer with respect to the first substrate;
the first sub-pixels have a length different from that of the second sub-pixels in the second direction and have the same length as that of the second sub-pixels in the first direction; and
the first sub-pixels are arrayed adjacent to each other along the first direction and the second sub-pixels are arrayed adjacent to each other along the first direction, and the first sub-pixels and the second sub-pixels are alternately arrayed along the second direction.

3. The liquid crystal device according to claim 1, the device further comprising a plurality of sub-pixels arrayed in a first direction and a second direction which intersect each other, wherein
the plurality of sub-pixels include first sub-pixels each containing the light-reflecting film provided to the second substrate and second sub-pixels each containing the light-emitting layer disposed at the opposite side of the liquid crystal layer with respect to the first substrate;
the first sub-pixels have a length different from that of the second sub-pixels in the first direction and have the same length as that of the second sub-pixels in the second direction; and
the first sub-pixels are arrayed adjacent to each other along the second direction and the second sub-pixels are arrayed adjacent to each other along the second direction, and the first sub-pixels and the second sub-pixels are alternately arrayed along the first direction.

4. The liquid crystal device according to claim 1, the device further comprising a plurality of sub-pixels arrayed in a first direction and a second direction which intersect each other, wherein
the plurality of sub-pixels include first sub-pixels each containing the light-reflecting film provided to the second substrate and second sub-pixels each containing the light-emitting layer disposed at the opposite side of the liquid crystal layer with respect to the first substrate; and
at least one of the first substrate and the second substrate is provided with monocolored or multicolored films in a predetermined arrangement so as to correspond to each of the first sub-pixels and the second sub-pixels.

5. The liquid crystal device according to claim 1, the device further comprising a plurality of sub-pixels arrayed in a first direction and a second direction which intersect each other, wherein
the plurality of sub-pixels include first sub-pixels each containing the light-reflecting film provided to the second substrate and second sub-pixels each containing the light-emitting layer disposed at the opposite side of the liquid crystal layer with respect to the first substrate;
a resin film for controlling the thickness of the liquid crystal layer is provided to the first substrate or the second substrate at the liquid crystal layer side in each of the first sub-pixels; and
the layer thickness t1 of the liquid crystal layer in the first sub-pixels and the layer thickness t2 of the liquid crystal layer in the second sub-pixels have a relationship as follows:
t1<t2.

6. A liquid crystal device comprising:
a first substrate and a second substrate which oppose each other;
a liquid crystal layer interposed between the first substrate and the second substrate;
a plurality of sub-pixels including first sub-pixels displaying an image at the first substrate side and second sub-pixels displaying an image at the second substrate side, wherein the first sub-pixels and the second-sub-pixels are arrayed in a first direction and in a second direction orthogonal to the first direction in a planar view in planar regions of the first substrate and the second substrate;
light-reflecting films reflecting light toward the direction of the first substrate, wherein the light-reflecting films are disposed on the second substrate in the first sub-pixels but not disposed in the second sub-pixels; and
light-emitting layers emitting color light toward the second substrate, wherein the light-emitting layers are disposed at the opposite side of the second substrate with respect to the first substrate in second sub-pixels but not disposed in the first sub-pixels.

7. The liquid crystal device according to claim 6, wherein
the first sub-pixels are provided with monocolored or multicolored films in a predetermined arrangement;
the color light emitted from one of the light-emitting layers is the same color as that of the color film provided in the first sub-pixel adjacent to the second sub-pixel provided with the one light-emitting layer.

8. A liquid crystal device comprising:
a first substrate and a second substrate which oppose each other;
a liquid crystal layer interposed between the first substrate and the second substrate;
a third substrate disposed at the opposite side of the second substrate with respect to the first substrate;
a fourth substrate disposed at the opposite side of the first substrate with respect to the third substrate;
a plurality of sub-pixels including first sub-pixels displaying an image at the first substrate side and second sub-pixels displaying an image at the second substrate side, wherein the first sub-pixels and the second sub-pixels are arrayed in a first direction and in a second direction orthogonal to the first direction in a planar view in planar regions of the first substrate and the second substrate;
a color film, a light-transmissive resin film disposed on the color film, and a light-transmissive electrode disposed on the light-transmissive resin film, in each first sub-pixel at the first substrate side;
a switching element, a resin film disposed on the switching element, and a light-reflecting film disposed on the resin film, in each first sub-pixel at the second substrate side;
light-transmissive electrodes disposed on the third substrate and light-emitting layers disposed on the light-transmissive electrodes; and
reflecting electrodes disposed on the fourth substrate so as to oppose the light-emitting layers.

9. The liquid crystal device according to claim 8, the device further comprising:
a switching element and a light-transmissive electrode disposed on the switching element and electrically connected to the switching element in each second sub-pixel at the first substrate side; and
a color film, a light-transmissive resin film disposed on the color film, and a light-transmissive electrode disposed on the light-transmissive resin film in each second sub-pixel at the second substrate side.

10. A liquid crystal device comprising:
a first substrate and a second substrate which oppose each other;
a liquid crystal layer interposed between the first substrate and the second substrate; and
a plurality of sub-pixels including first sub-pixels displaying an image at the first substrate side and second sub-pixels displaying an image at the second substrate side, wherein
the first sub-pixels and the second sub-pixels are arrayed in a first direction and in a second direction orthogonal to the first direction in a planar view in planar regions of the first substrate and the second substrate; and
the first sub-pixels and the second sub-pixels are alternately disposed in either or both the first and second directions.

11. The liquid crystal device according to claim 10, wherein the first sub-pixels and the second sub-pixels are separately driven.

12. The liquid crystal device according to claim 11, wherein the first sub-pixels and the second sub-pixels are provided with switching elements; and a group of the switching elements provided to the first sub-pixels and a group of the switching elements provided to the second sub-pixels are separately driven.

13. An electronic apparatus comprising a liquid crystal device according to claim 1.
